(19) United States
(12) Patent Application Publication
(10) Pub. No.: US 2026/0274124 A1
(43) Pub. Date: Sep. 17, 2026

(54) ENGAGEMENT FEATURES AND RECEIVING FEATURES OF ROTATING CHILD RESTRAINT SYSTEM

(71) Applicant: Evenflo Company, Inc., Miamisburg, OH (US)

(72) Inventor: Eric Dahle, Ludlow Falls, OH (US)

(21) Appl. No.: 19/079,037

(22) Filed: Mar. 13, 2025

(51) Int. Cl. B60N 2/28

(52) U.S. Cl. CPC B60N 2/2869; B60N 2/2821; B60N 2/2872

(57) ABSTRACT

Embodiments of the present disclosure include a CRS comprising a seat shell comprising a plurality of engagement features, and a base comprising a plurality of corresponding engagement features. When the seat shell is rotated along a support surface of the base, at least some of the plurality of engagement features of the seat shell may interact with at least some of the plurality of engagement features of the base, retaining the seat shell in the base when experiencing any one or more directional impacts.

### BACKGROUND

In the United States, child restraint systems (CRS), such as child car seat systems, are required by law and recommended for children of certain ages or sizes. There are many types of CRSs available for purchase. Infant CRSs recommended for children under age 1 are typically rearward-facing. Many CRSs may be convertible such that the seat shell may be in a rearward-facing position suitable for children under age 1 and then converted to a forward-facing position for children over the age of 1. Such convertible CRSs are typically designed such that the CRS may be uninstalled, repositioned, and reinstalled within the vehicle in the forward-facing position. In some versions of convertible CRSs, the seat shell may rotate within the base such that the seat shell is selectively positionable between a plurality of positions (e.g., the rearward-facing position, the forward-facing position, an intermediate loading position). It would be desirable to provide improved engagement and receiving features of each of the base and the seat shell such that complete uninstallation is not required to selectively position the CRS between the forward-facing position and the rearward-facing position. It would be further desirable to design improved engagement and receiving features that can retain the seat shell in the base when experiencing one or more directional impacts (e.g., forward, oblique, lateral, and/or rearward impacts).

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIG. 1 is a side perspective view of a child restraint system (CRS) in accordance with an embodiment disclosed herein.

FIG. 2 is an exploded side perspective view of the CRS of FIG. 1 in the forward-facing position.

FIG. 3 is a back perspective view of the seat shell of the CRS of FIG. 1 uncoupled from the base.

FIG. 4 is a back plan view of the seat shell of the CRS of FIG. 1 uncoupled from the base.

FIG. 5 is a back plan view of the seat shell structural element of the CRS of FIG. 1.

FIG. 6 is a front perspective view of the seat shell structural element of the CRS of FIG. 1.

FIG. 7 is a top-down view of the seat shell structural element of the CRS of FIG. 1.

FIG. 8 is a bottom-up view of the seat shell structural element of the CRS of FIG. 1.

FIG. 9 is a front perspective view of the base of the CRS of FIG. 1.

FIG. 10 is a front plan view of the base structural element of the CRS of FIG. 1.

FIG. 11 is a front perspective view of the base structural element of the CRS of FIG. 1.

FIG. 12 is a top-down view of the base structural element of the CRS of FIG. 1.

FIG. 13 is a bottom-up view of the base structural element of the CRS of FIG. 1.

FIG. 14 is an exploded cross-sectional view of the CRS of FIG. 1 taken at cutline 14-14 in FIG. 1.

FIG. 15 is a front perspective view of the seat shell structural element and the base structural element of the CRS of FIG. 1 in an engaged position.

FIG. 16 is a cross-sectional detail view of the first and second pair of engagement features and the first and second pair of receiving features of the CRS of FIG. 1 in an engaged position taken at cutline 16-16 in FIG. 15.

FIG. 17 is another detail view of a portion of the first and second pair of engagement features and the first and second pair of receiving features of the CRS of FIG. 1 in an engaged position.

FIG. 18 is a cross-sectional detail view of a portion of the second pair of engagement features and the portion of the second pair of receiving features of the CRS of FIG. 1 taken at cutline 18-18 in FIG. 15.

FIG. 19 is a top-down perspective view of the seat shell structural element and the base structural element of the CRS of FIG. 1 in the engaged position.

FIG. 20 is a front perspective view of another embodiment of the CRS of FIG. 1.

FIG. 21 is an exploded cross-sectional view of a portion of the pair of forward engagement features and the portion of the first pair of receiving features of the CRS of FIG. 1 taken at cutline 21-21 in FIG. 20.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

“A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. Unless indicated otherwise, all measurements provided herein are taken when a component(s) is at standard ambient temperature and pressure (298.15 K and 100 kPa). As used herein, the terms “substantially” and “about” mean within ±5% of an indicated value. As used in the description and the accompanying claims, a value is considered to be “approximately” equal to a stated value if it is neither more than 5 percent greater than nor more than 5 percent less than the stated value. In addition, a disclosure of a range is to be understood as specifically disclosing all values and further divided ranges within the range.

It should be noted that some of the terms used herein may be relative terms. For example, the terms “upper” and “lower” and the terms “front” and “rear” are relative to each other in location, e.g., an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” or “base” are used to refer to surfaces where the top is always higher than the bottom/base relative to an absolute reference, i.e., the surface of the Earth. The terms “upwards” or “upwardly” and “downwards” or “downwardly” are also relative to an absolute reference; upwards is always against the gravity of the Earth. The terms “front” or “forward” and “rear” or “rearward” with respect to a position or orientation are opposite one another along a common direction, and an “intermediate” position is always located between a forward position and a rearward position. The term “parallel” should be construed in its lay sense of two surfaces that maintain a generally constant distance between them, and not in the strict mathematical sense that such surfaces will never intersect when extended to infinity. The terms “operative to” and “adapted to” and similar terms are used herein to describe that a particular component has certain structural features designed to perform a designated function. Such components should be construed as having the expressed structure, with the designated function being considered part of the structure. The term “engage” and similar terms are used herein to describe the interaction between particular components and does not necessarily require that such components contact one another (directly or indirectly). As used herein and as will be appreciated by those skilled in the art, the term “CRS” encompasses CRSs, safety seats, restraints, boosters, and the like for children, infants, toddlers, and the like.

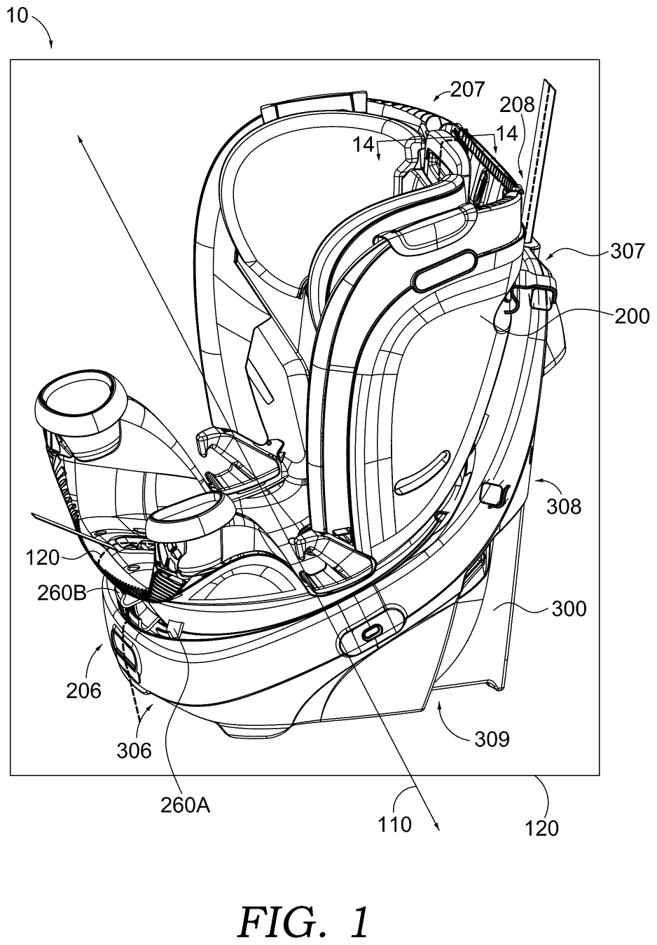

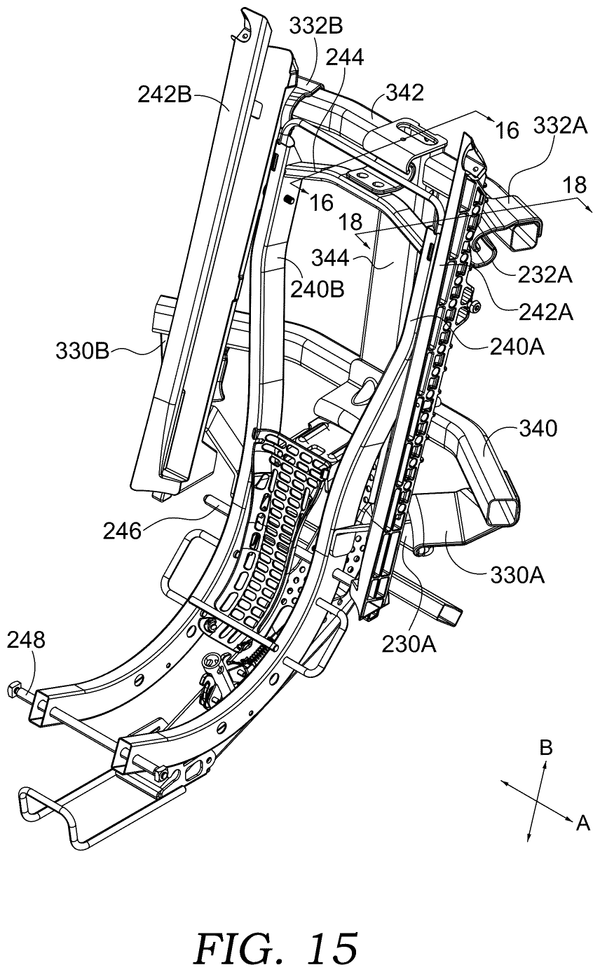

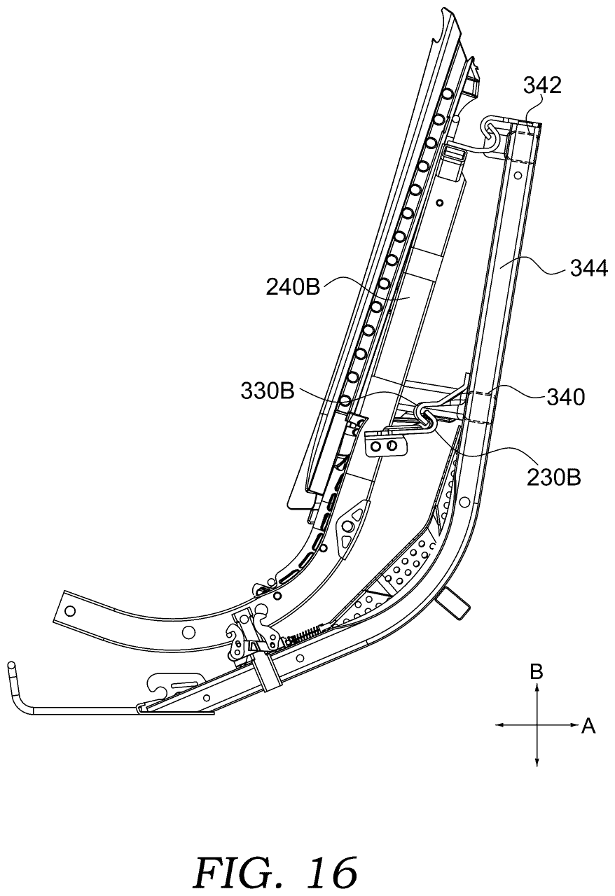

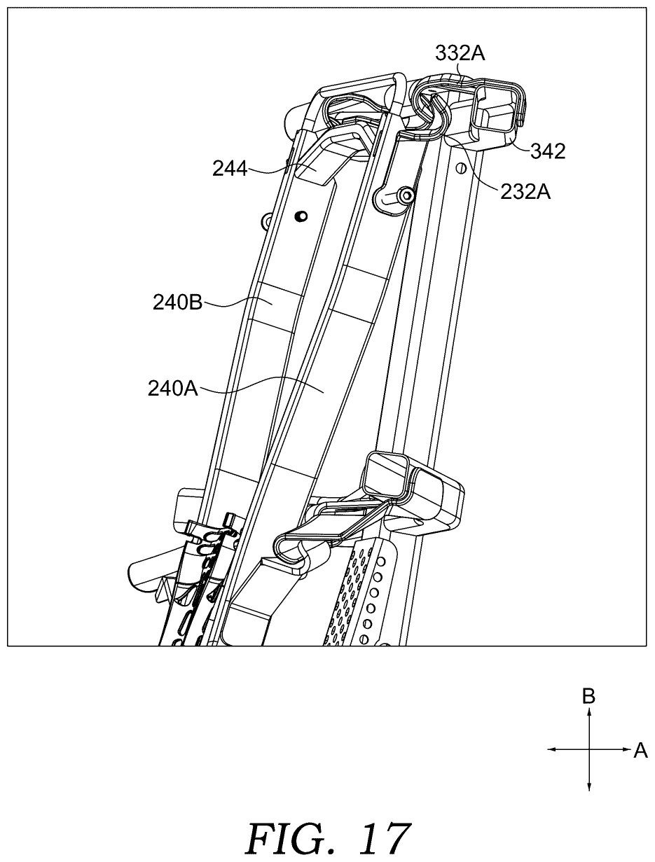

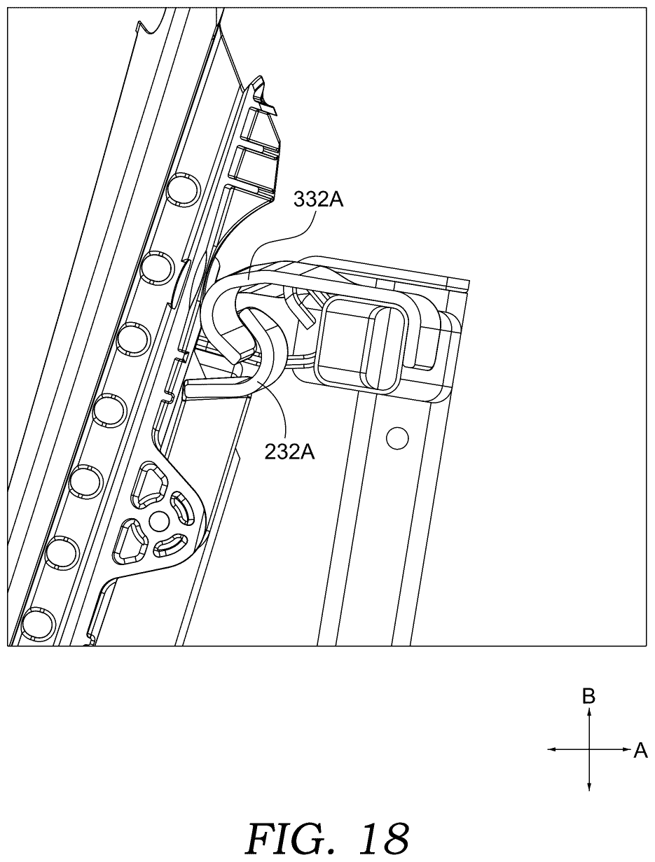

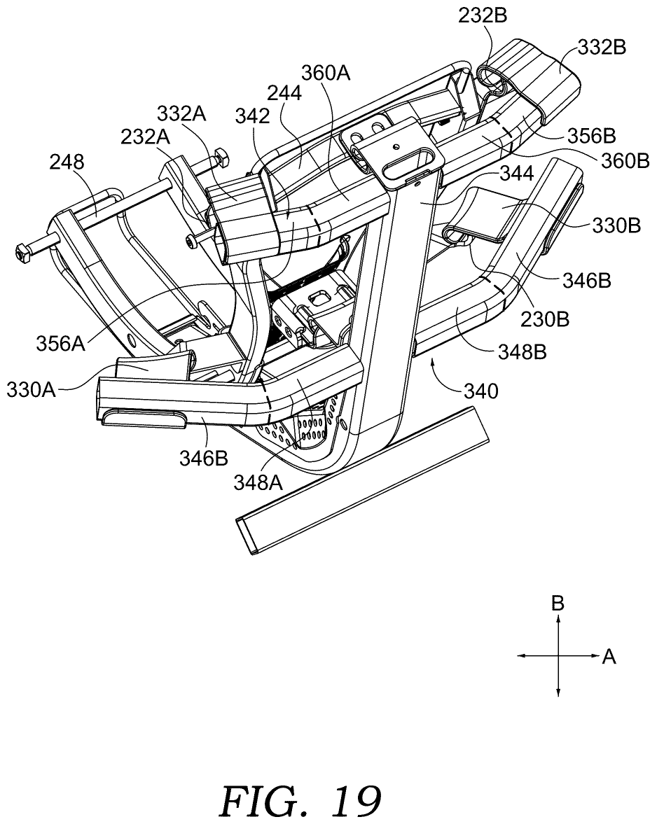

In accordance with aspects of the disclosure, exemplary embodiments of CRSs are illustrated in various levels of specificity in FIGS. 1-21. As will be appreciated by those skilled in the art, the CRSs described herein may be convertible CRSs that are convertible between at least two configurations. For example, a CRS described herein may be convertible between a forward-facing configuration and a rearward-facing configuration. In another example, a CRS described herein is convertible between a forward-facing configuration and a rearward-facing configuration, and a booster configuration. In yet another example, a CRS described herein is convertible between a forward-facing configuration and a rearward-facing configuration, a high-back booster configuration, and a backless booster configuration. The CRSs of the present disclosure may be configured to support an infant, child, toddler, older children, and the like.

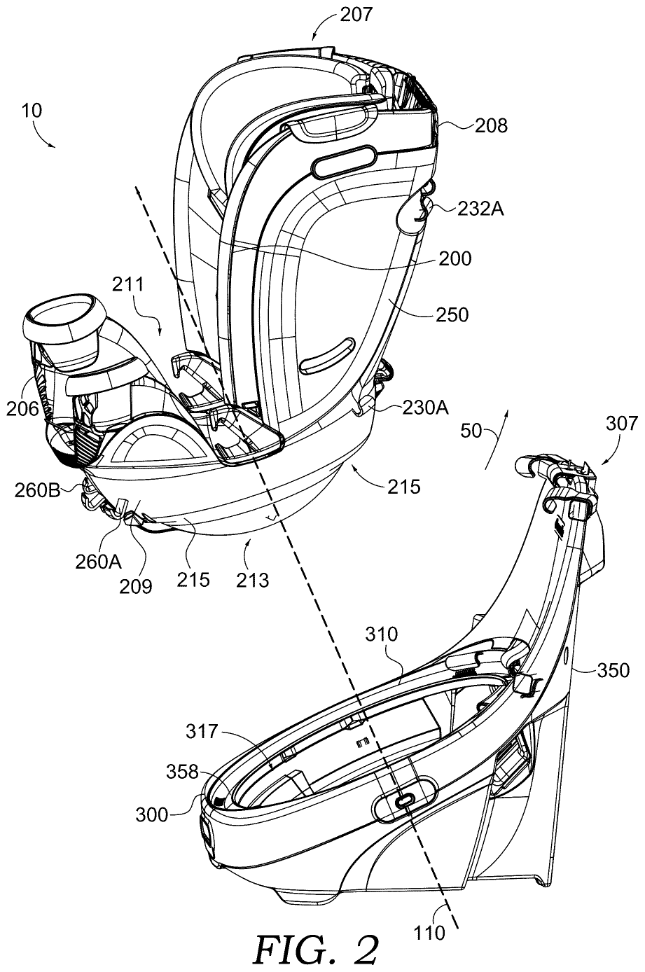

As illustrated in FIG. 1, very generally, CRS 10 is designed for safely transporting an infant or child in a vehicle, such as a car. The CRS 10 generally includes a seat shell 200, which is supported on a base 300. As will be readily understood by those skilled in the art, the CRS 10 may be affixed to the seat of a vehicle (e.g., car, truck, passenger van), such as by a seat belt (e.g., lap belt) of the car extending through a belt path. The seat shell 200 may include a front 206 and a rear 208 opposite the front 206. The seat shell 200 may include a headrest 207 and a bottom surface 213 (as can be seen in FIG. 2) located vertically inferior to the headrest 207. The bottom surface 213 may form a curved, rounded, or convex outwardly protruding surface, such that the bottom surface 213 is semi-hemispherical or substantially semi-spherical, in one example. The base 300 may further include a front 306 and a rear 308 opposite the front 306. The base 300 may further include an upper wall 307 and a bottom 309 located vertically inferior to the upper wall 307.

Now referring to FIG. 2, the base 300 may support and stabilize the seat shell 200. In particular, the base 300 may include a receiving portion 310 that generally operates to support the seat shell 200 on the base 300, which may be supported on a seat of a vehicle. For example, at least a portion of the seat shell 200 may be received by and/or within the receiving portion 310 of the base 300. Put another way, the receiving portion 310 of the base 300 may be configured to interface with at least a portion of the seat shell 200. More specifically, the receiving portion 310 may be configured to interface with the seat shell 200 on the bottom surface 213 of the seat shell 200. It is contemplated that the base 300 may comprise a single structure or multiple structures that are secured together such that they could not be uncoupled by a user.

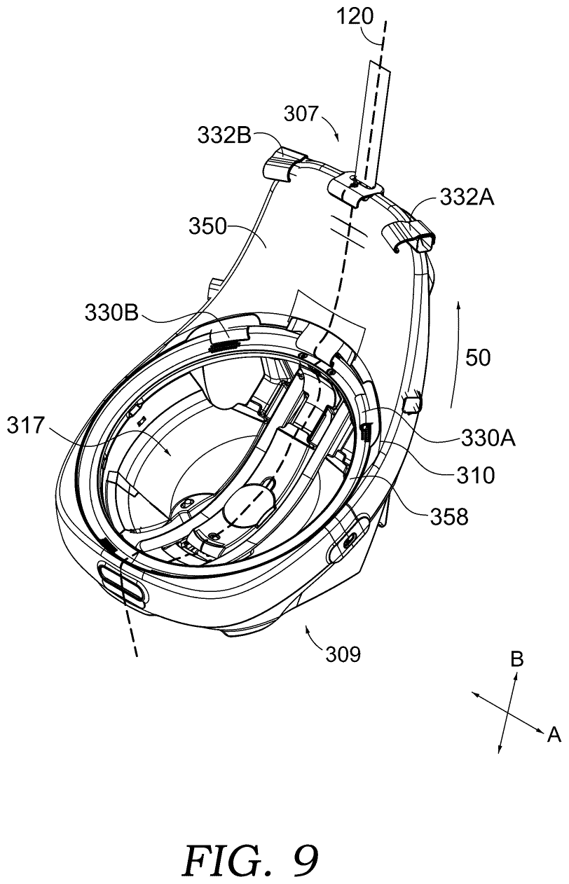

The seat shell 200 includes a bottom 209 and a back 250. The bottom 209 of the seat shell 200 may generally support and stabilize a seat of the occupant. An occupant may be seated on a top side 211 of the seat shell 200, which may be fitted with soft goods to provide a comfortable occupant experience. The back 250 may extend upwardly away from the bottom 209, such as extending upwardly from the bottom 209 proximate the rear 208 of the seat shell 200. In some aspects, the base 300 also includes a backing portion 350 that extends in a substantially vertical direction upwardly from the bottom 309 at the rear 308 of the base up to a superior edge of the upper wall 307 of the base (i.e., in the direction of arrow 50). The backing portion 350 may comprise a forward surface (e.g., a surface of the backing portion 350 facing the front 306) and a rear surface (e.g., a surface of the backing portion 350 facing the rear 308). The backing portion 350 may be wider in the horizontal direction at a location adjacent to the receiving portion 310 and narrower relative to this location at a location adjacent to the upper wall 307, as can be seen in FIG. 9. The backing portion 350 may assist in supporting the back 250 of the seat shell 200.

As shown in FIGS. 2 and 9, the receiving portion 310 of the base 300 may be contoured, curved, and concave so as to at least partially define a hollow bowl-like shape. In this way, the receiving portion 310 of the base 300 generally defines or forms a hollow cavity 317 that is sized and shaped to receive at least a portion of the seat shell 200. In one example, the receiving portion 310 may be oriented at a non-right angle relative to the vertically extending direction of the backing portion 350, and a plane that corresponds to the bottom 309 of the base and which is substantially horizontal. In one example, the receiving portion 310 and the cavity 317 formed therein are tilted relative to the backing portion 350 such that the cavity 317 of the receiving portion 310 is angled toward the front 306 of the base 300. In one example, the cavity 317 may be semi-hemispherical or substantially semi-spherical in shape, extending downward into the body of the base 300, at a non-right angle relative to the bottom 309 and relative to the backing portion 350. The size, shape, and angle of the cavity 317 formed by the medial surfaces of the receiving portion 310 allows the bottom surface 213 of the seat shell 200 to snugly fit and nest within the cavity 317, as further discussed hereinafter. In some embodiments and as described further herein, the seat shell 200 may be rotatable with respect to the base 300 such that the base 300 may operate to support the seat shell 200 for rotation with respect thereto, which is enabled by the hollow, concave shape of the cavity formed by the receiving portion 310 thus receiving the convex protruding shape of the bottom surface 213 of the seat shell 200 and enabling the bottom surface 213 to rotate within the cavity 317 formed by the receiving portion 310. In some aspects, the seat shell 200 may be rotatable with respect to the base 300 and a rotational axis 110 while the seat shell 200 is secured by the receiving portion 310 within the cavity 317 of the base 300. In aspects, the seat shell 200 is rotatable with respect to the base 300 around the rotational axis 110 (which is centrally positioned relative to the concave shape of the cavity 317 and the angle of the cavity 317) to selectively position the seat shell 200 in one or more positions (e.g., forward-facing, rearward-facing, intermediate positions between the forward-facing and rearward-facing positions, etc.) relative to the base 300.

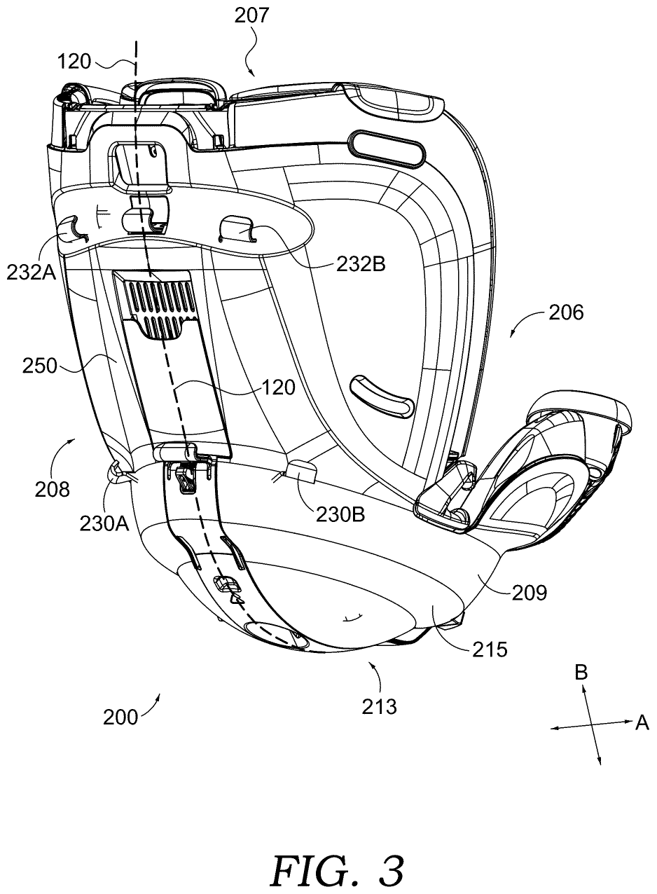

In aspects, the bottom surface 213 of the bottom 209 includes one or more portions having varying degrees of contouring or curvature. For example, the bottom surface 213 includes a contoured surface 215 that interfaces with the receiving portion 310 of the base 300, by abutting one or more surfaces of the receiving portion 310. The contoured surface 215 may circumscribe a medial-portion of the bottom surface 213, relative to the rotational axis 110, and the curvature of the contoured surface 215 may be less than a medial-most portion of the of the bottom surface 213, as visible in FIG. 3. As shown in FIGS. 2 and 9, the receiving portion 310 of the base 300 includes a support surface 358, which may also be referred to as a support ledge or a rounded ledge. The contoured surface 215 of the bottom 209 abuts the support surface 358 of the base 300. In some embodiments, the seat shell 200 rotates with respect to the base 300, and the support surface 358 generally operates as a surface along which at least the seat shell 200 (e.g., the contoured surface 215) travels as the seat shell 200 is rotated with respect to the base 300. In this way, the support surface 358 may be viewed as a track along which the seat shell 200 rotates. As can be appreciated, the support surface 358 may be an arcuate track that circumscribes the cavity 317. The support surface 358 may comprise a lateral edge abutting a receiving surface of the receiving portion 310. The support surface 358 may take the form of a flange or a lip medially extending away from the receiving surface of the receiving portion 310 and toward the rotational axis 110. In aspects, the receiving surface of the receiving portion 310 and the support surface 358 form a groove in which the contoured surface 215 of the bottom 209 of the seat shell 200 comes into contact with. In some embodiments, the support surface 358 is circular or substantially circular in shape and may define an opening to the cavity 317 of the receiving portion 310 of the base 300.

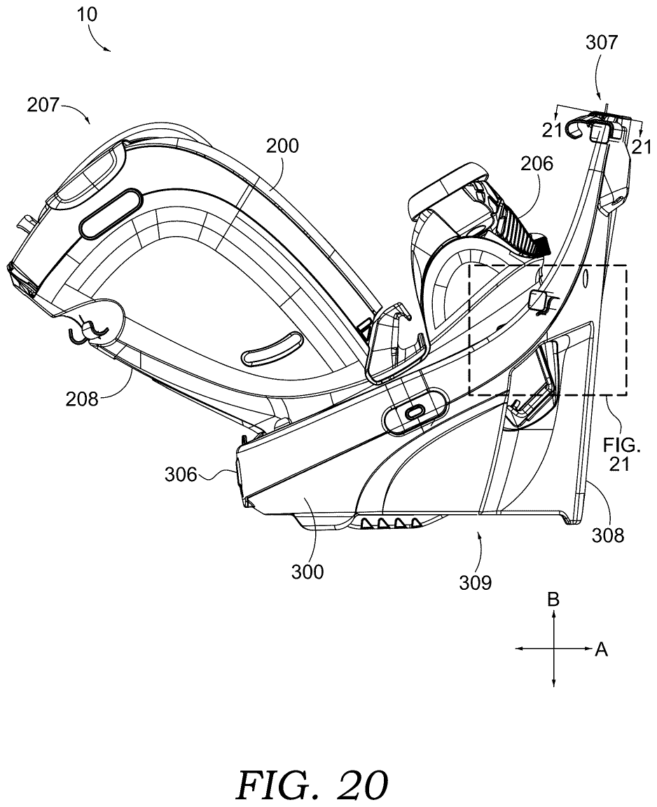

In aspects, the seat shell 200 may be rotated along the support surface 358 of the receiving portion 310 and be secured in a forward-facing position, as shown in FIG. 1, or a rear-facing position (e.g., where the front 206 of the seat shell 200 is rotated away from the front 306 of the base 300 toward the rear 308 of the base 300), or any one or more intermediate positions (e.g., where the front 206 of the seat shell 200 is rotated away from each of the front 306 and the rear 308 of the base 300), as shown in FIG. 20.

The rotational axis 110 may extend through each of the seat shell 200 and the base 300. The rotational axis 110 extends substantially through and/or along a vertical plane 120. The vertical plane 120 corresponds to a sagittal plane that is disposed longitudinally and vertically through the seat shell 200 when the seat shell 200 is either configured to be front-facing or rear-facing and is disposed longitudinally and vertically through the base 300 when the base supports the seat shell in any nested position, wherein the vertical plane 120 bisects the seat shell 200 and the base 300 into first and second halves, or right and left halves, for example.

In exemplary aspects, the seat shell 200 comprises a plurality of engagement features that engage or mate with a plurality of corresponding engagement features on the base 300 to keep the seat shell 200 positioned within the receiving portion 310 of the base 300 and/or lock rotation of the seat shell 200 with respect to the base 300 at one or more positions. In this way, an engagement feature on the seat shell 200 may selectively engage with a corresponding engagement feature of the base 300 so that when the seat shell 200 is in the forward-facing position and/or the rearward-facing position, the seat shell 200 remains safe and secure when experiencing any one or more directional impacts, preventing the seat shell 200 from disengaging from the base 300. As shown in FIGS. 3-8, the seat shell 200 may include a plurality of engagement features, and the base 300 includes a plurality of receiving features, as shown in FIGS. 9-13; however, it is expressly contemplated that the base 300 may include the plurality of engagement features, and the seat shell 200 may include the plurality of receiving features, or the base 300 and the seat shell 200 may each include a combination of engagement and receiving features. Further, although pairs of engagement features are shown and discussed herein, it will be understood that any quantity of engagement features are contemplated and considered to be within the scope of this Description.

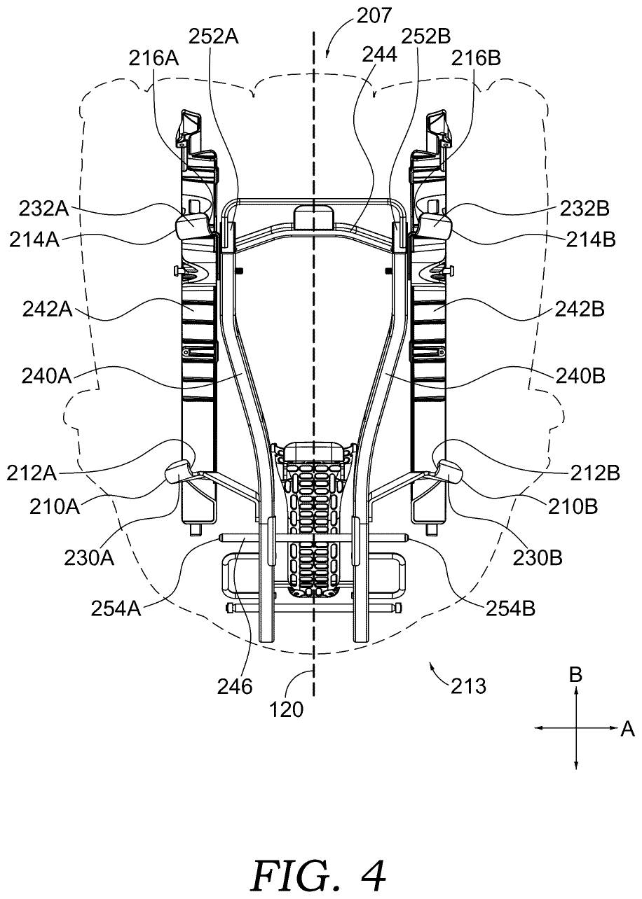

Now referring to FIGS. 3-4, in aspects, the seat shell 200 includes a first pair of engagement features, wherein that first pair comprises a first engagement feature 230A and a second engagement feature 230B. In aspects, the first pair of engagement features 230A, 230B, are each offset from a midline, also referred to as the vertical plane 120 of the seat shell 200. The first pair of engagement features 230A, 230B may have reflectional symmetry to one another across the midline defined by the vertical plane 120. In aspects, the first pair of engagement features 230A, 230B, are horizontally aligned in the same horizontal plane relative to each other such that each of the engagement features 230A, 230B of the first pair is positioned on opposite sides of the vertical plane 120. In aspects, each engagement feature 230A, 230B of the first pair has a lateral side 210A, 210B and a medial side 212A, 212B.

In aspects, the first pair of engagement features 230A, 230B may comprise a pair of upward-oriented hooks (e.g., extending upward relative to the bottom 209, as shown in FIGS. 3-8), downward-oriented hooks (e.g., extending downward relative to the headrest 207), or a combination thereof. In such aspects, the first pair of engagement features 230A, 230B may each comprise a shank and a lip. The shank is the relatively straight and/or substantially planar portion of the hook extending laterally and horizontally away from the vertical plane 120, and each lip may comprise the curved portion extending from the shank to a terminal end of the hook. In some aspects, such as those shown in FIGS. 4-6, the shank is coupled to and/or integrally formed with an attachment member. As will be further discussed herein, the attachment member may enable the coupling of the shank and lip to a seat structural element. The attachment member of each of the first pair of engagement features 230A, 230B may comprise one or more segments. The one or more segments of the attachment member of each of the first pair of engagement features 230A, 230B may have a non-parallel and a non-perpendicular relationship with one another. For example, as shown in FIGS. 4-6, a first segment of the attachment member of each of the first pair of engagement features 230A, 230B may have a downward slope in the lateral-to-medial direction until reaching a second segment of the attachment member, which extends downward toward the bottom 209 of the seat shell 200 and/or extends vertically parallel relative to the vertical plane 120.

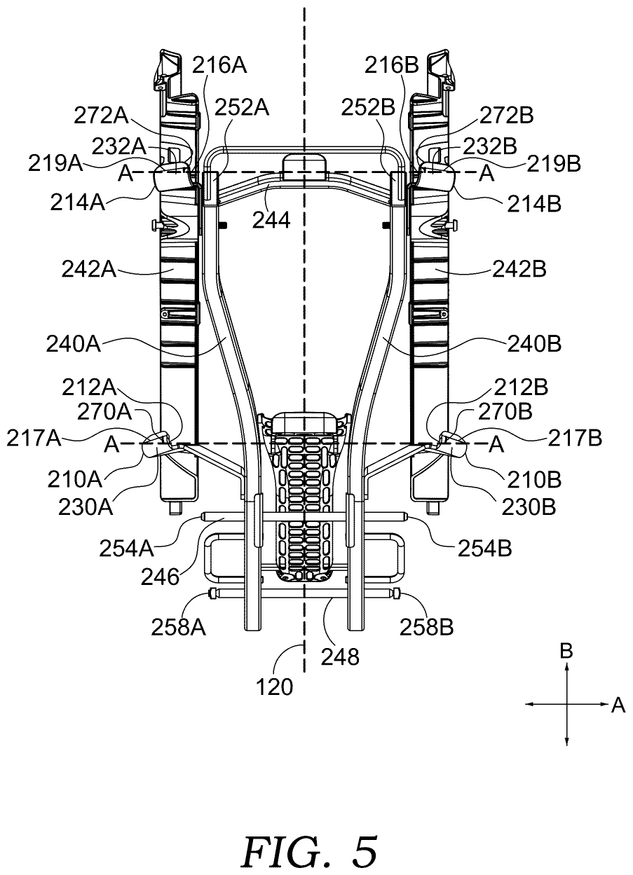

As shown in FIG. 5, in one example, the horizontal axes 217A, 217B of each of the first pair of engagement features 230A, 230B may have a non-parallel orientation with respect to the each other, such that the first pair of engagement features 230A, 230B are angled relative to a horizontal direction A, as represented by angles 270A, 270B. The horizontal direction A may be approximately parallel to a surface upon which the CRS 10 is placed (e.g., a seat of a vehicle). As such, each of the first pair of engagement features 230A, 230B may be angled medially toward the midline (e.g., the vertical plane 120). For example, each hook has a shank or a body that is angled medially toward the midline, and a curved lip, wherein the lip is shown as bending upward in the direction of the headrest 207. In aspects, such as those shown in FIGS. 4-6, the medial sides 212A, 212B of the curved lips of the engagement features 230A, 230B may be at a higher elevation (“raised”) and/or angled upward relative to the lateral sides 210A, 210B of each of the curved lips of the first pair of engagement features 230A, 230B. Thus, the first pair of engagement features 230A, 230B have a downward sloping angle in a medial-to-lateral direction, as visible in FIG. 5. In other aspects, the lateral sides 210A, 210B may be raised and/or angled upward relative to the medial sides 212A, 212B of each of the first pair of engagement features 230A, 230B when the curved lip of each of the first pair of engagement features 230A, 230B is oriented to bend downward so that the hook opens in an downward direction, toward the bottom 209.

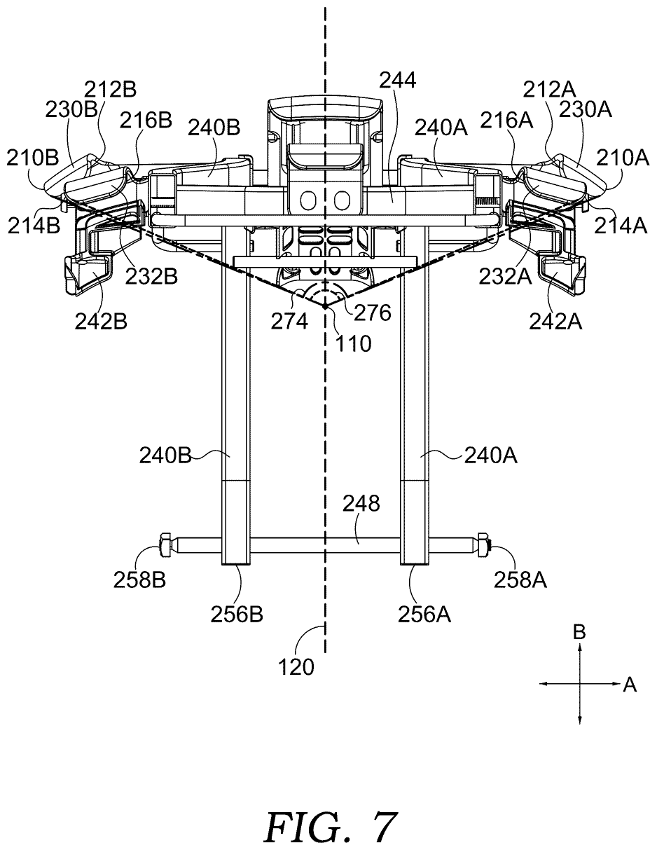

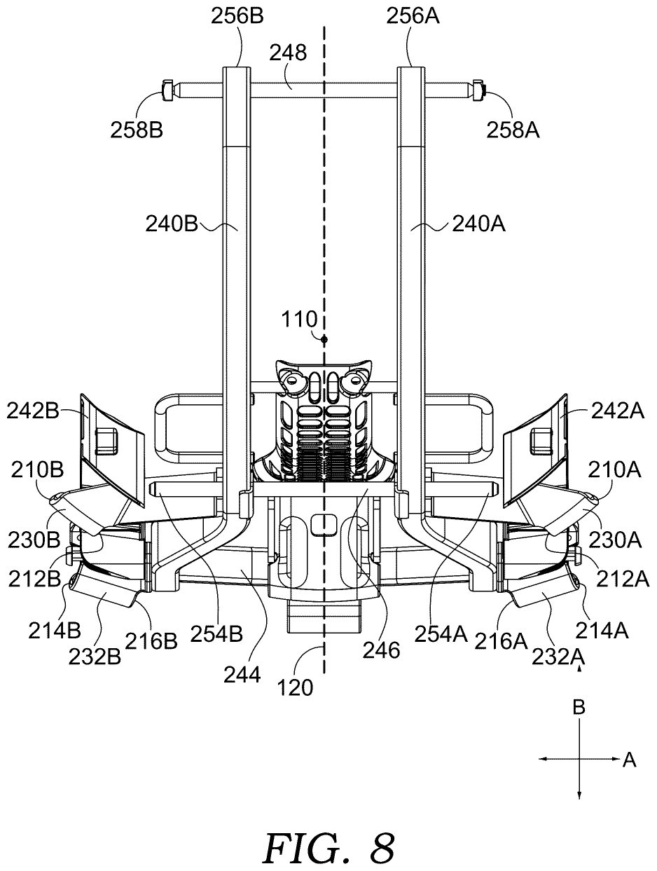

In aspects, as shown in FIGS. 7-8, the first pair of engagement features 230A, 230B may have a first angle 274 spanning between them, as measured from the rotational axis 110 (as is represented by the dot in FIGS. 7-8). In aspects, the first angle 274 is measured between the lateral sides 210A, 210B of each of the first pair of engagement features 230A, 230B. In aspects, the first angle 272 formed between the first pair of engagement features 230A, 230B is from 80° to 170° from the rotational axis 110. The first angle 272 may comprise a pair of adjacent angles between the vertical plane 120 and each of the first pair of engagement features 230A, 230B. Each of the pair of adjacent angles may be from 20° to 85° from the vertical plane 120. In some aspects, the pair of adjacent angles are the same (as shown in FIGS. 7-8), and in other aspects, the pair of adjacent angles are different.

In aspects, the seat shell 200 includes a second pair of engagement features 232A, 232B, wherein the second pair comprises a third engagement feature 232A and a fourth engagement feature 232B. In aspects, the second pair of engagement features 232A, 232B are each offset from the vertical plane 120 disposed longitudinally and vertically through the rotational axis 110 when the seat shell 200 is in the forward-facing position and in the rearward-facing position. In aspects, the second pair of engagement features 232A, 232B may have reflectional symmetry to one another across the midline defined by the vertical plane 120. In aspects, the second pair of engagement features 232A, 232B, are aligned in the same horizontal plane relative to each other and each engagement feature 232A, 232B of the second pair is positioned on opposite sides of the vertical plane 120 relative to each other. In aspects, the second pair of engagement features 232A, 232B are positioned vertically offset from the first pair of engagement features 230A, 230B. In aspects, each engagement feature 232A, 232B of the second pair includes a lateral side 214A, 214B and a medial side 216A, 216B.

In aspects, the second pair of engagement features 232A, 232B may comprise a pair of upward-oriented hooks (e.g., extending upward relative to the bottom 209, as shown in FIGS. 3-8), downward-oriented hooks (e.g., extending downward relative to the headrest 207), or a combination thereof. In such aspects, the second pair of engagement features 232A, 232B may each comprise a shank and a lip, as described with respect to the first pair of engagement features 230A, 230B. In some aspects, such as those shown in FIGS. 4-6, the shank is coupled to and/or integrally formed with an attachment member. The attachment member of each of the second pair of engagement features 232A, 232B may comprise one or more segments that extend downward toward the bottom 209 of the seat shell 200. In aspects, the attachment member of each of the second pair of engagement features 232A, 232B extends vertically downward toward the bottom 209 of the seat shell 200 and/or extends vertically parallel relative to the vertical plane 120.

As is shown in FIG. 5, a horizontal axis 219A, 219B of each of the second pair of engagement features 232A, 232B may have a non-parallel orientation with respect to each other such that each of the second pair of engagement features 232A, 232B are angled relative to the horizontal direction A, as represented by angles 272A, 272B. As such, each of the second pair of engagement features 232A, 232B may be angled medially toward the midline. For example, each hook has a shank or a body that is angled medially toward the midline, and a curved lip, wherein the lip is shown as bending upward in the direction of the headrest 207. In aspects, such as those shown in FIGS. 4-6, the medial sides 216A, 216B of the curved lips of the engagement features 232A, 232B may be raised and/or angled upward relative to the lateral sides 214A, 214B of each of the curved lips of the second pair of engagement features 232A, 232B. Thus, the engagement features 232A, 232B have a downward sloping angle in a medial-to-lateral direction, as visible in FIG. 5. In other aspects, the lateral sides 214A, 214B may be raised and/or angled upward relative to the medial sides 216A, 216B of each of the second pair of engagement features 232A, 232B when the curved lip of each of the engagement features 232A, 232B is oriented to bend downward so that the hook opens in a downward direction, toward the bottom 209.

In aspects, such as those shown in FIG. 5, each horizontal axis 217A, 217B of the first pair of engagement features 230A, 230B each have a larger angle 270A, 270B relative to the horizontal direction A than the angles 272A, 272B of each horizontal axis 219A, 219B of the second pair of engagement features 232A, 232B. For example, the horizontal axis 217A, 217B of each of the first pair of engagement features 230A, 230B may be angled 10° relative to the horizontal direction A while the horizontal axis 219A, 219B of each of the second pair of engagement features 232A, 232B may be angled 5° relative to the horizontal direction A. In aspects, the horizontal axes 217A, 217B of each of the first pair of engagement features 230A, 230B and the horizontal axes 219A, 219B of the second pair of engagement features 232A, 232B are angled approximately the same amount relative to the horizontal direction A (e.g., within 3° of each other).

In aspects, as can be seen in FIGS. 7-8, the second pair of engagement features 232A, 232B may have a second angle 276 spanning between them, as measured from the rotational axis 110. In aspects, the second angle 276 is measured between the lateral sides 214A, 214B of each of the second pair of engagement features 232A, 232B. In aspects, the second angle 276 between the lateral sides 214A, 214B of each of the second pair of engagement features 232A, 232B is from 80° to 170° from the rotational axis 110. The second angle 276 may comprise a pair of adjacent angles between the vertical plane 120 and each of the first pair of engagement features 232A, 232B as measured from the rotational axis 110. Each of the pair of adjacent angles may be from 40° to 85° from the vertical plane 120. In some aspects, the pair of adjacent angles are the same (e.g., within 3° of each other), and in other aspects, the pair of adjacent angles are different.

In aspects, the first angle 274 formed between the first pair of engagement features 230A, 230B is the same as the second angle 276 formed between the second pair of engagement features 232A, 232B. In such aspects, the first pair of engagement features 230A, 230B may be aligned vertically with the second pair of engagement features 232A, 232B when viewing the seat shell 200 from a top-down or a bottom-up view (such as the views shown in FIGS. 7-8). In aspects, the first angle 274 formed between the first pair of engagement features 230A, 230B is different from the second angle 276 formed between the second pair of engagement features 232A, 232B. In such aspects, the first angle 274 may be larger than the second angle 276, as shown in FIGS. 7-8. In such aspects, the first pair of engagement features 230A, 230B may each be vertically offset from each of the second pair of engagement features 232A, 232B, such that they are not aligned when viewed top-down (as shown in FIG. 7). For example, the first angle 274 may be 170° and the second angle 276 may be 150°. In another example, the first angle 274 may be 130° and the second angle 276 may be 120°.

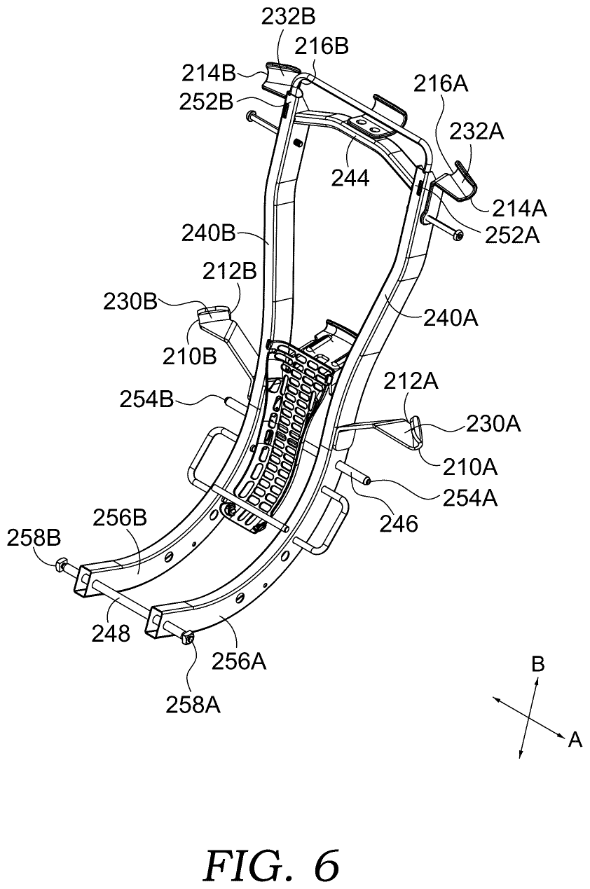

As shown in FIGS. 5-8, in aspects, the first pair 230A, 230B and the second pair 232A, 232B of engagement features are each secured to and/or are integrally formed with a seat shell structural element at least partially disposed within the seat shell 200 (as can be seen in FIG. 4). The seat structural element may comprise one or more rails and one or more horizontal elements extending between, through, and/or across the one or more rails. As is appreciated, in other aspects, the seat structural element may take other forms and generally extends throughout the rear 208 of the seat shell 200. In aspects, the seat structural element extends into the seat bottom 209 and/or to the front 206 of the seat shell 200 (as shown in FIG. 6). The seat structural element may be a component within a larger structure of the seat shell 200, and may be joined to the larger structure within the seat shell 200. The seat structural element may be coupled to and/or formed with one or more other components, such as a seat plate and/or one or more stabilizing features. The seat structural element may be formed of any one or more suitable materials, such as steel (e.g., carbon steel), aluminum, titanium, copper alloys, polycarbonate, acrylonitrile butadiene styrene (ABS), fiber-reinforced polymers, and the like.

The seat structural element may comprise one or more rails, such as a pair of rails 240A, 240B. In exemplary aspects, the pair of rails 240A, 240B are vertically aligned with each other. In aspects, the pair of rails 240A, 240B extend in a substantially parallel orientation in at least one region along the pair of rails 240A, 240B relative to each other. In the example shown in FIGS. 4-6, the pair of rails 240A, 240B may be parallel at or near the bottom 209 and taper laterally at a central region to be parallel at or near the headrest 207 of the seat shell 200. In other examples, the pair of rails 240A, 240B may extend in a non-parallel orientation relative to each other in at least one region along the pair of rails 240A, 240B, such as at the central region of the rear 208 of the seat shell 200 positioned approximately equidistant between the bottom 209 and the headrest 207. In other aspects, the pair of rails 240A, 240B extend in a parallel orientation relative to each other substantially along the pair of rails 240A, 240B, or the pair of rails 240A, 240B extend in a non-parallel orientation substantially along the pair of rails 240A, 240B.

In some aspects, each of the first pair of engagement features 230A, 230B and the second pair of engagement features 232A, 232B are integrally formed with the pair of rails 240A, 240B, and in other aspects, each of the first pair of engagement features 230A, 230B and the second pair of engagement features 232A, 232B are affixed to the pair of rails 240A, 240B. In aspects, each of the first pair of engagement features 230A, 230B and the second pair of engagement features 232A, 232B are positioned on a lateral side of each of the pair of rails 240A, 240B. The first pair of engagement features 230A, 230B may be positioned on each lateral side of the pair of rails 240A, 240B at a lower region of the seat shell 200 adjacent to the bottom 209. The second pair of engagement features 232A, 232B may be positioned on each lateral side of the pair of rails 240A, 240B at the upper wall 307 of the base, such as at a first end 252A, 252B of each of the pair of rails 240A, 240B. As one example, the attachment member of each of the first pair 230A, 230B and the second pair 232A, 232B (e.g., the second segment of the attachment member) of engagement features allow coupling and/or affixation of the first pair 230A, 230B and the second pair of engagement features 232A, 232B to the lateral sides of each of the pair of rails 240A, 240B.

In aspects, each of the first pair of engagement features 230A, 230B and the second pair of engagement features 232A, 232B may be attached or coupled to the lateral sides of each of the pair of rails 240A, 240B using any one or more of welding, adhesives, riveting, screws, bolts, threaded inserts, and the like. The first pair of engagement features 230A, 230B and/or the second pair of engagement features 232A, 232B may be attached to the pair of rails 240A, 240B via a pair of attachment structures 242A, 242B. The pair of attachment structures 242A, 242B may be vertically aligned, and the pair of attachment structures 242A, 242B may be positioned on the lateral sides of the pair of rails 240A, 240B. As shown in FIGS. 4-5, in aspects, a plurality of screws may extend through openings of the pair of attachment structures 242A, 242B to secure the first pair of engagement features 230A, 230B to the pair of rails 240A, 240B. As shown in FIGS. 4-5 the second pair of engagement features 232A, 232B are coupled to the lateral sides of each of the pair of rails 240A, 240B using welding.

In aspects, the one or more horizontal elements, such as a first horizontal element 244, a second horizontal element 246, and/or a third horizontal element 248, extend between, across, and/or through the pair of rails 240A, 240B. One or more of the horizontal elements 244, 246, 248 may be separate components affixed to and/or coupled to the pair of rails 240A, 240B and/or one or more of the horizontal elements 244, 246, 248 may be integrally formed with the pair of rails 240A, 240B to form the seat shell structural element. One or more of the horizontal elements 244, 246, 248 may be affixed to the pair of rails using any one or more of welding, adhesives, riveting, screws, and the like, and in some aspects, the horizontal elements 244, 246, 248 may be secured to the pair of rails 240A, 240B by one or more screws extending through the attachment structures 242A, 242B and into the horizontal elements 244, 246, 248. In aspects, any one or more of the horizontal elements 244, 246, 248 are rods that are configured to be inserted into corresponding openings on the pair of rails 240A, 240B, and in such aspects, the rods may be of varying lengths (e.g., such that a first end and a second end of the rod each extend beyond the openings on the pair of rails 240A, 240B in the lateral direction when inserted into the openings).

The first horizontal element 244 may be positioned proximate the first end 252A, 252B of each of the pair of rails 240A, 240B. In aspects, the first horizontal element 244 extends between each medial side of each of the pair of rails 240A, 240B. As shown in FIGS. 4-6, the first horizontal element 244 is shown as a horizontal rail, but it is expressly contemplated that the first horizontal element may take other forms, such as those of the second horizontal element 246 and/or the third horizontal element 246. Further, it is contemplated that the second horizontal element 246 and/or the third horizontal element 248 may have any one or more features of the first horizontal element 244.

The second horizontal element 246 may be positioned at and/or proximate to the lower region of the seat shell 200 adjacent to the bottom 209, and in aspects, the second horizontal element 246 is positioned proximate to and/or below the first pair of engagement features 230A, 230B along the pair of rails 240A, 240B. In aspects, the second horizontal element 246 may extend through each of the pair of rails 240A, 240B such that a first end 254A and a second end 254B each extend beyond the lateral sides of each of the pair of rails 240A, 240B when the second horizontal element is inserted between the pair of rails 240A, 240B. In aspects, each of the first end 254A and the second end 254B of the second horizontal element 246 may be coupled to bolts or other retaining elements at each end such that the bolts prevent the second horizontal element 246 from exiting the openings of the pair of rails 240A, 240B.

As shown in FIG. 6, the third horizontal element 248 may be positioned at and/or proximate to a second end 256A, 256B of each of the pair of rails 240A, 240B in the front 206 of the seat shell 200. In aspects, the third horizontal element 248 extends through corresponding openings of each of the pair of rails 240A, 240B such that a first end 258A and a second end 258B of the third horizontal element 248 extend beyond the lateral sides of each of the pair of rails 240A, 240B, similar to the second horizontal element 246. As described, each of the first end 258A and the second end 258B may be coupled to bolts or other retaining elements such that the third horizontal element 248 is prevented from exiting the openings of the pair of rails 240A, 240B.

In aspects, the second horizontal element 246 has a second length, and the third horizontal element 248 has a third length. In aspects, any one or more of the first length, the second length, or the third length may be the same or they may be different. In aspects, the first length is the same as the second length. In aspects, the second length is larger than the third length. In aspects, any one or more of the horizontal elements 244, 246, 248 may extend beyond the lateral sides of the pair of rails 240A, 240B.

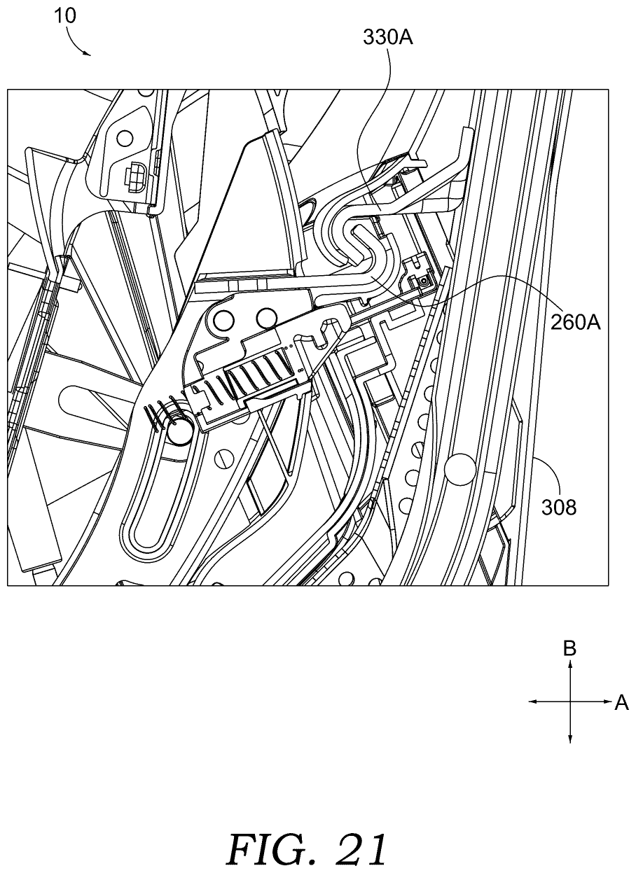

As shown in FIGS. 1 and 2, in aspects, the seat shell 200 includes a pair of forward engagement features 260A (e.g., a first forward engagement feature), 260B (e.g., a second forward engagement feature) at the front 206 of the seat shell 200. In aspects, the pair of forward engagement features 260A, 260B comprise a pair of upward-oriented hooks (as shown in FIGS. 20-21), downward-oriented hooks, or a combination thereof. The pair of forward engagement features 260A, 260B are each offset from the vertical plane 120 disposed longitudinally and vertically through the rotational axis 110 when the seat shell 200 is in the forward-facing position and when the seat shell 200 is in the rearward-facing position. The pair of forward engagement features 260A, 260B may have any one or more aspects as described with respect to the first pair of engagement features 230A, 230B and/or the second pair of engagement features 232A, 232B.

In aspects, the first pair 230A, 230B, the second pair 232A, 232B, and/or the pair of forward engagement features 260A, 260B of the seat shell 200 selectively engage and/or lock with a plurality of engagement features of the base 300. In aspects, such as those shown in FIGS. 9-13, the plurality of engagement features of the base 300 are a plurality of receiving features.

Now referring to FIGS. 9-13, the base 300 may include a first pair of receiving features comprising a first receiving feature 330A and a second receiving feature 330B. In aspects, each receiving feature 330A, 330B of the first pair is positioned proximate to the support surface 258, along which at least a portion of the seat shell 200 contacts as the seat shell 200 is rotated. In aspects, the first pair of receiving features 330A, 330B, are each offset from the midline, also referred to as the vertical plane 120 of the base 300. The vertical plane 120 corresponds to a sagittal plane that is disposed longitudinally and vertically through the base 300, wherein the vertical plane 120 bisects the base 300 into first and second halves, or right and left halves, for example. In aspects, the first pair of receiving features 330A, 330B are horizontally aligned such that each receiving feature 330A, 330B of the first pair is positioned on the same horizontal plane relative to each other such that each of the first pair of receiving features 330A, 330B is positioned on opposite sides of the vertical plane 120. In aspects, each of the receiving features 330A, 330B of the first pair has a lateral side 312A, 312B and a medial side 314A, 314B.

In aspects, each receiving feature 330A, 330B of the first pair may comprise a complimentary upward-oriented hook (e.g., extending upward relative to the bottom 309), downward-oriented hook (e.g., extending downward relative to the upper wall 307, as shown in FIGS. 9-11), or a combination thereof, which may engage with the first pair of engagement features 230A, 230B when the seat shell 200 rotates to the forward-facing position and/or which may engage with the pair of forward engagement features 260A, 260B when the seat shell 200 rotates to the rearward-facing position. In such aspects, the first pair of receiving features 330A, 330B may each comprise a shank and a lip. The shank is the relatively straight and/or substantially planer portion of the hook extending medially toward the vertical plane 120, and each lip may comprise the curved portion extending from the shank to a terminal end of the hook.

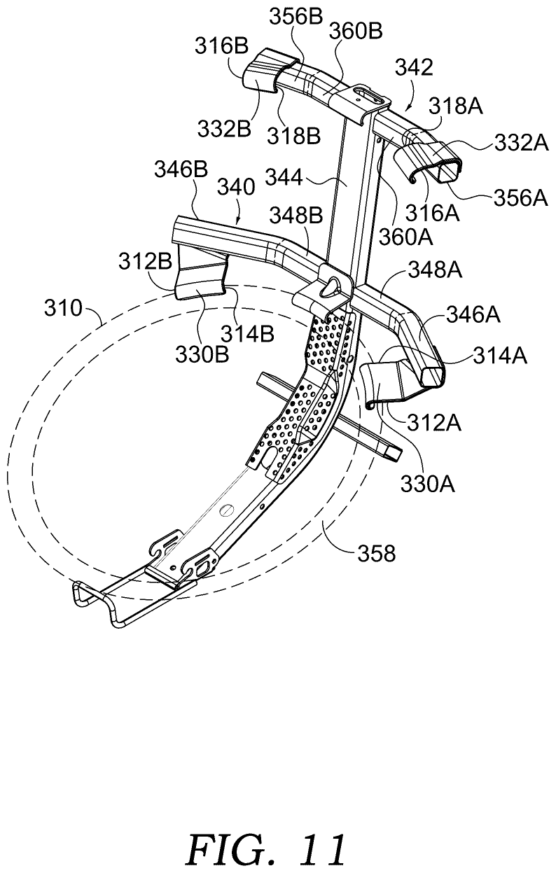

In some aspects, such as those shown in FIG. 11, the shank is coupled to and/or integrally formed with an attachment member. As will be further discussed herein, the attachment member may enable the coupling of the shank and the lip to a base structural element. The attachment member of each of the first pair of receiving features 330A, 330B may comprise one or more segments. In one example, as shown in FIG. 11, a first segment of the attachment member extends around a bottom side (e.g., facing the bottom 309 of the base 300) and a posterior side (e.g., facing the rear 308 of the base 300) of the base structural element. In this example, a second segment extends at a downward angle (e.g., toward the cavity 317) from a lower edge of the first segment to meet the shank. In this example, as shown in FIG. 11, the second segment of the attachment member of each of the first pair of receiving features 330A, 330B may be triangular in shape, which enables positional angling of each of the first pair of receiving features 330A, 330B toward the vertical plane 120.

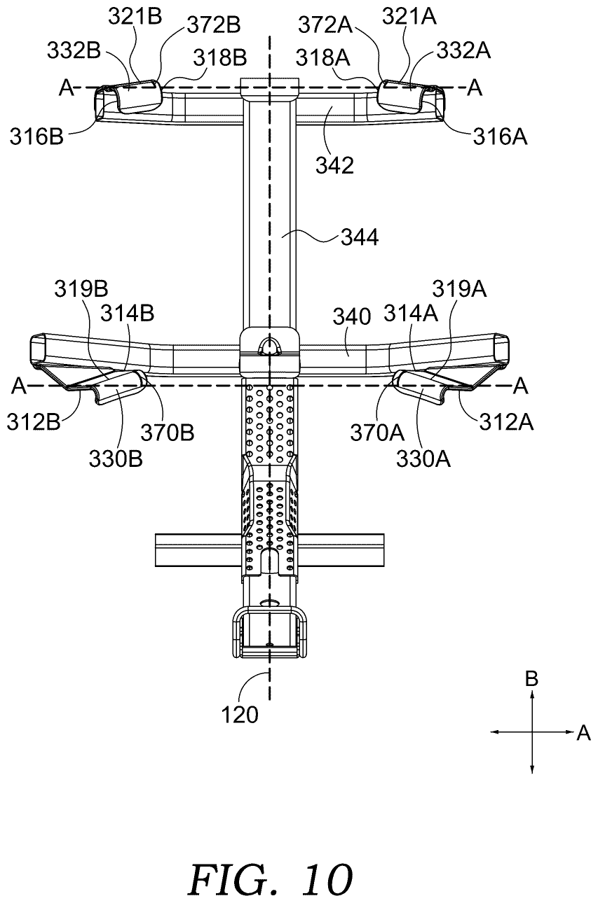

As shown in FIG. 9, in one example, each horizontal axis 319A, 319B of the first pair of receiving features 330A, 330B have a non-parallel orientation with respect to each other, such that the first pair of receiving features 330A, 330B is angled relative to the horizontal direction A, represented by angles 370A, 370B. As such, each of the first pair of receiving features 330A, 330B may be angled medially toward the vertical plane 120. For example, each hook has a shank or a body that is angled medially toward the vertical plane 120, and a curved lip, wherein the lip is shown as bending downward in the direction of the bottom 309. In aspects, such as those shown in FIGS. 9-11, the medial sides 314A, 314B of the curved lip of each receiving feature 330A, 330B of the first pair may be raised and/or angled relative to the lateral sides 312A, 312B of the curved lip of each of the first pair of receiving features 330A, 330B. Thus, the first pair of receiving features 330A, 330B have a downward sloping angle in a medial-to-lateral direction, as visible in FIG. 10. In other aspects, the lateral sides 312A, 312B may be raised and/or angled upward relative to the medial sides 314A, 314B of each of the first pair of receiving features 330A, 330B when the curved lip of each of the first pair of receiving features 330A, 330B is oriented to bend upward so that the hook opens in an upward direction, toward the upper wall 307. In aspects, the angle 370A, 370B of the horizontal axis 319A, 319B of each of the first pair of receiving features 330A, 330B is the same (e.g., within 3° of) as the angle 270A, 270B of the horizontal axis 217A, 217B of each of the first pair of engagement features 230A, 230B of the seat shell 200.

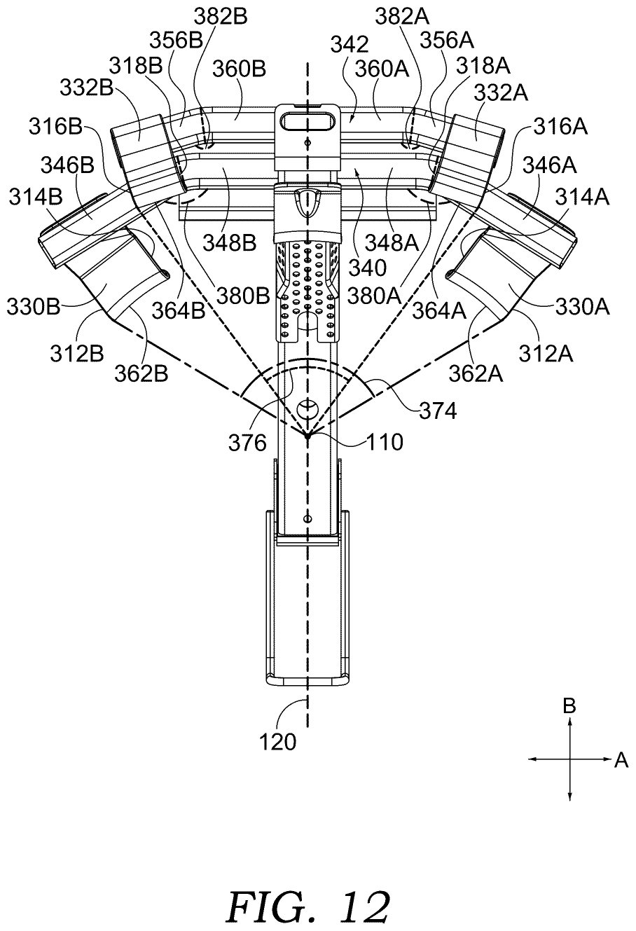

In aspects, as shown in FIG. 12, a first angle 374 spans between the lateral sides 312A, 312B of each of the first pair of receiving features 330A, 330B, across the vertical plane 120, as measured from the rotational axis 110. In aspects, the first angle 374 is between 20° to 160° and/or is the same angle (e.g., within 3° of) as the first angle 274 spanning between the lateral sides 210A, 210B of the first pair of engagement features 230A, 230B. The first angle 374 may comprise a pair of adjacent angles. In aspects, each receiving feature 330A, 330B of the first pair is positioned at a first adjacent angle from the vertical plane 120, as measured from the rotational axis 110. In such aspects, the first adjacent angle may be between 1° and 80°, such as between 30° to 70°, from the vertical plane 120.

The base 300 may include a second pair of receiving features 332A, 332B positioned on the backing portion 350 of the base 300. In aspects, the second pair of receiving features 332A, 332B are positioned near and/or at the upper wall 307 of the base 300. In aspects, the second pair of receiving features 332A, 332B are each offset from the vertical plane 120 disposed longitudinally and vertically through the rotational axis 110. In aspects, the second pair of receiving features 332A, 332B, are horizontally aligned such that each receiving feature 332A, 332B of the second pair is positioned on the same horizontal plane relative to each other such that each of the second pair of receiving features 332A, 332B are positioned on opposite sides of the vertical plane 120. In aspects, each of the receiving features 332A, 332B of the second pair has a lateral side 316A, 316B and a medial side 318A, 318B.

In aspects, each receiving feature 332A, 332B of the second pair may comprise a complimentary upward-oriented (e.g., extending upward relative to the bottom 309) hook, downward-oriented hook (e.g., extending downward relative to the upper wall 307, as shown in FIGS. 9-11), or a combination thereof, which may engage with the second pair of engagement features 232A, 232B when the seat shell 200 rotates to the forward-facing position. In such aspects, the second pair of receiving features 332A, 332B may each comprise a shank and a lip. The shank is the relatively straight and/or substantially planer portion of the hook extending medially toward the vertical plane 120, and each lip may comprise the curved portion extending from the shank to a terminal end of the hook. In some aspects, such as those shown in FIG. 11, the shank is coupled to and/or integrally formed with an attachment member of the second pair of receiving features 332A, 332B. As will be further discussed herein, the attachment member may enable the coupling of the shank and the lip to the base structural element. In one example, as shown in FIG. 11, the attachment member extends around a top side (e.g., facing the upper wall 307 of the base 300) and a posterior side (e.g., facing the rear 308 of the base 300) of the base structural element.

As shown in FIG. 9, in one example, each horizontal axis 321A, 321B of the second pair of receiving features 332A, 332B may have a non-parallel orientation with each other such that the second pair of receiving features 332A, 332B are angled relative to the horizontal direction A, as represented by angles 372A, 372B. For example, each hook has a shank or a body that is angled medially toward the midline, and a curved lip, wherein the lip is shown as bending downward in the direction of the bottom 309 of the base 300. In aspects, such as those shown in FIGS. 9-11, the medial sides 318A, 318B of the curved lip of each receiving feature 332A, 332B of the second pair may be raised relative to the lateral sides 316A, 316B of the curved lips of the second pair of receiving features 332A, 332B. Thus, the second pair of receiving features 332A, 332B have a downward sloping angle in a medial-to-lateral direction, as visible in FIG. 10. In other aspects, the lateral sides 316A, 316B may be raised and/or angled upward relative to the medial sides 318A, 318B of each of the second pair of receiving features 332A, 332B when the curved lip of each of the second pair of receiving features 332A, 332B is oriented to bend upward so that the hook opens in an upward direction, toward the upper wall 307. In aspects, the angle 372A, 372B of the horizontal axis 321A, 321B of each of the second pair of receiving features 332A, 332B is the same (e.g., within 3° of) as the angle 272A, 272B of the horizontal axis 219A, 219B of each of the second pair of engagement features 232A, 232B of the seat shell 200.

In aspects, such as those shown in FIGS. 10-11, the horizontal axis 319A, 319B of each of the first pair of receiving features 330A, 330B has a larger angle 370A, 370B relative to the horizontal direction A than the angle 372A, 372B of the horizontal axis 321A, 321B of each of the second pair of receiving features 332A, 332B relative to the horizontal direction A. For example, the horizontal axis 319A, 319B of each of the first pair of receiving features 330A, 330B may be angled 10° relative to the horizontal direction A while each horizontal axis 321A, 321B of each of the second pair of engagement features 232A, 232B may be angled 5° relative to the horizontal direction A. In aspects, the medial sides 314A, 314B, 318A, 318B of each of the first pair of engagement features 230A, 230B and the second pair of engagement features 232A, 232B are angled approximately the same amount (e.g., within 3° of each other).

In aspects, as is shown in FIG. 12, a second angle 376 spans between the lateral sides 316A, 316B of each of the second pair of receiving features 332A, 332B. In aspects, the second angle 376 is between 20° to 160° and/or is the same angle (e.g., within 3° of) as the second angle 276 spanning between the lateral sides 214A, 214B of the second pair of engagement features 232A, 232B. The second angle 376 may comprise a pair of adjacent angles. In aspects, each receiving feature 332A, 332B of the second pair is positioned at a second adjacent angle from the vertical plane 120, as measured from the rotational axis 110, such as from 1° to 80°, such as from 30° to 70° from the vertical plane 120. In such aspects, the second adjacent angle of each of the second pair of receiving features 332A, 332B relative to the vertical plane 120 may be different (e.g., smaller than) from the first adjacent angle of each of the first pair of receiving features 330A, 330B relative to the vertical plane 120 (e.g., the first adjacent angle is 60° and the second adjacent angle is 40° from the vertical plane 120).

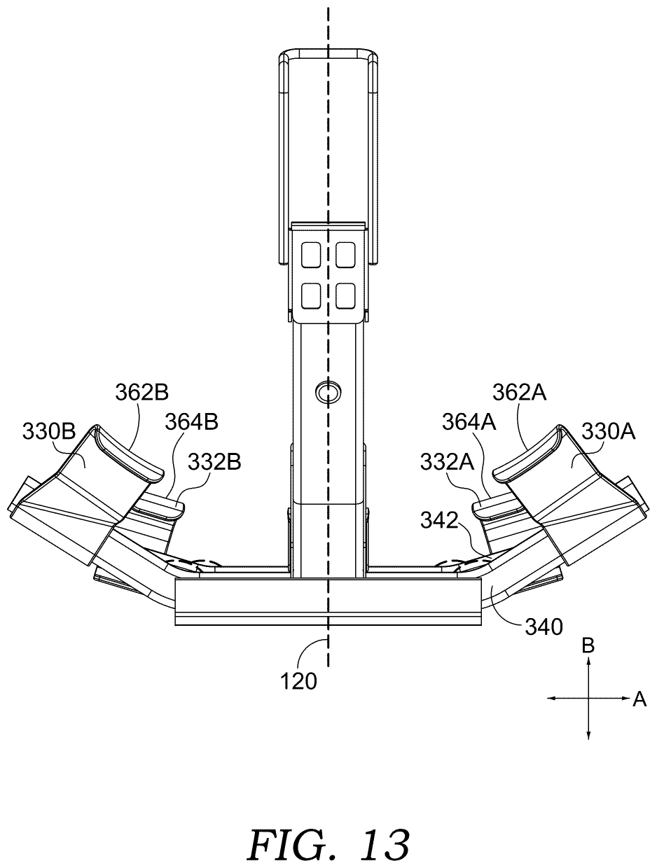

In aspects, each of the first pair of receiving features 330A, 330B may have a forward contour 362A, 362B, and each of the second pair of receiving features 332A, 332B may have a forward contour 364A, 364B. In aspects, the forward contours 362A, 362B, 364A, 364B may generally be considered the projected boundary of a curved lip when the first pair 330A, 330B and the second pair of receiving features 332A, 332B are viewed from a top-down and/or a bottom-up view (as shown in FIGS. 12-13). In aspects, the contour of the forward contour 362A, 362B of the first pair 330A, 330B, from the top-down view of the base structural element (as shown in FIG. 12), has a negative curvature such that the forward contour 362A, 362B of each of the first pair of receiving features 330A, 330B have the same or similar curvature as the receiving portion 310. In aspects, the contour of the forward contour 364A, 364B of each of the second pair of receiving features 332A, 332B, from the top-down view, has reduced or no curvature. Advantageously, providing negative curvature at the forward contour 362A, 362B of the first pair 330A, 330B allows free rotation of the seat shell 200 along the support surface 358, while providing reduced or no curvature at the forward contour 364A, 364B of the second pair 332A, 332B allows for the upper wall 307 of the base to be less rounded and/or curved and provide a comfortable occupant experience.

Now referring to FIGS. 10-13, in aspects, the first pair of receiving features 330A, 330B and/or the second pair of receiving features 332A, 332B are secured to or integrally formed with the base structural element at least partially disposed within the base 300 (as shown in FIG. 9). In one example, such as is shown in FIGS. 11-13, each of the first pair of receiving features 330A, 330B and the second pair of receiving features 332A, 332B are coupled and/or affixed to the base structural element via the attachment member, such as by the attachment member extending around the top side (e.g., facing the upper wall 307 of the base 300), the bottom side (e.g., facing the bottom 309 of the base 300), the posterior side (e.g., facing the rear 308 of the base 300) of the base structural element, or a combination of these.

The base structural element may include one or more armatures, such as a first armature 340 and a second armature 342. The base structural element may include a central component 344 extending along the vertical direction B between the one or more armatures. In aspects, the base structural element may extend from the upper wall 307 of the base 300, through the rear 308 of the base 300 in the vertical direction B. In some aspects, the base structural element may extend under the receiving portion 310 of the base 300 to extend into the front 306 of the base 300 (as shown in FIG. 11). The base structural element may be a component within a larger structure of the base 300, and may be joined to the larger structure within the base 300. The base structural element may be coupled to and/or formed with any one or more additional features (e.g., seat shell support plate, supporting features). The base structural element may be formed of any one or more suitable materials, such as steel (e.g., carbon steel), aluminum, titanium, copper alloys, polycarbonate, ABS, UHMWPE, fiber-reinforced polymers, and the like.

In aspects, such as those shown in FIGS. 10-13, the first armature 340 and/or the second armature 342 each extend horizontally across the vertical plane 120 such that each of the terminal ends of each of the first armature 340 and the second armature 342 are positioned on opposite sides of the vertical plane 120. In some aspects, the first armature 340 and/or the second armature 342 are integrally formed with the central component 344 (e.g., are non-removably coupled to the central component 344), and in other aspects, the first armature 340 and/or the second armature 342 are removably coupled to the central component 344. In aspects, the first pair of receiving features 330A, 330B are secured to or integrally formed with the first armature 340 on opposite sides of the vertical plane 120. In aspects, the second pair of receiving features 332A, 332B are secured to or are integrally formed with the second armature 342 on opposite sides of the vertical plane 120. While the first pair 330A, 330B and the second pair of receiving features 332A, 332B are shown as coupled to the terminal ends of the first armature 340 and the second armature 342, it is contemplated that they may be positioned at any one or more locations distinct from the terminal ends of the first armature 340 and the second armature 342.

In aspects, the first armature 340 is vertically offset along the central component 344 from the second armature 342. For example, the first armature 340 may be positioned on a first horizontal plane and the second armature 342 may be positioned on a second horizontal plane, wherein the first horizontal plane is lower in elevation along the vertical direction B than the first horizontal plane. The first armature 340 may be positioned proximate the support surface 358 at a position posterior to the support surface 358 and/or at a position superior to the support surface 358. The second armature 342 may be positioned at and/or near the upper wall 307 of the base 300, as shown in FIG. 9, and in some aspects, the second armature 342 may be positioned at a terminal edge of the upper wall 307 of the base 300. The first armature 340 may be positioned lower in elevation along the central component 344 than the second armature 342.

In some aspects, the first armature 340 and/or the second armature 342 are each a single longitudinal component and each continuously extend across and/or through each of the central component 344 (which may have openings that receive the first armature 340 and/or the second armature 342) and the vertical plane 120. In other aspects, the first armature 340 and/or the second armature 342 each comprise at least a first segment and a second segment, with each of the first and second components coupled to and/or integrally formed with the central component 344. In aspects, each of the first armature 340 and/or the second armature 342 comprises a plurality of segments that extend in a non-parallel orientation in the horizontal direction A with respect to each other. In some aspects, each of the plurality of segments are two or more separate components that may be coupled together via any one or more methods described herein. In other aspects, each of the plurality of segments are integrally formed with one or more of each other and/or the central component 344.

In exemplary aspects, the first armature 340 may comprise a pair of lateral segments comprising a first lateral segment 346A and a second lateral segment 346B. Further, the first armature 340 may comprise a pair of medial segments comprising a first medial segment 348A and a second medial segment 348B. The pair of lateral segments 346A, 346B may be positioned along a horizontal plane of the first armature 340 and comprise segments positioned further from the vertical plane 120 than the pair of medial segments 348A, 348B. The pair of medial segments 348A, 348B may be positioned along the horizontal plane of the first armature 340 and each extend between a non-terminal end of each of the pair of lateral segments 346A, 346B and the central component 344. In aspects, as shown in FIGS. 11-12, the attachment members of each of the first pair of receiving features 330A, 330B are coupled to the pair of lateral segments 346A, 346B at each of their terminal ends.

In aspects, a first interior angle 380A spans between the first lateral segment 346A and the first medial segment 348A of the first armature 340, and a second interior angle 380B spans between the second lateral segment 346B and the second medial segment 348B of the first armature 340. In aspects, each of the first interior angle 380A and/or the second interior angle 380B may be from 100° to 160°. In aspects, the first interior angle 380A and the second interior angle 380B of the first armature 340 are the same, as shown in FIG. 12, and in other aspects, the first interior angle 380A and the second interior angle 380B of the first armature 340 are different.

In aspects, the second armature 342 may comprise a pair of lateral segments comprising a first lateral segment 356A and a second lateral segment 356B. The second armature 342 may comprise a pair of medial segments comprising a first medial segment 360A and a second medial segment 360B. The pair of lateral segments 356A, 356B may be positioned along a horizontal plane of the second armature 342 and comprise segments positioned further from the vertical plane 120 than the pair of medial segments 360A, 360B. The pair of medial segments 360A, 360B may be positioned along the horizontal plane of the second armature 342 and each extend between a non-terminal end of each of the pair of lateral segments 356A, 356B and the central component 344. In aspects, as shown in FIGS. 11-12, the attachment members of each of the second pair of receiving features 332A, 332B are coupled to the pair of lateral segments 356A, 356B at each of their terminal ends.

In aspects, a first interior angle 382A spans between the first lateral segment 356A and the first medial segment 360A of the second armature 342, and a second interior angle 382B spans between the second lateral segment 356B and the second medial segment 360B of the second armature 342. In aspects, the first interior angle 382A and/or the second interior angle 382B may be from 100° to 160°. In aspects, the first interior angle 382A and the second interior angle 382B of the second armature 342 are the same, as shown in FIG. 12, and in other aspects, the first interior angle 382A and the second interior angle 382B of the second armature 342 are different.

In some aspects, the first interior angle 380A of the first armature 340 is the same as the first interior angle 382A of the second armature 342, and in other aspects, such as those shown in FIGS. 12-13 and 19, the first interior angle 380A of the first armature 340 is different than the first interior angle 382A of the second armature 342. In aspects, the first interior angle 380A of the first armature 340 is smaller than the first interior angle 382A of the second armature 342. For example, the first interior angle 380A of the first armature 340 may be 140°, and the first interior angle 382A of the second armature 342 may be 160°. In some aspects, the second interior angle 380B of the first armature 340 is the same as the second interior angle 382B of the second armature 342, and in other aspects, such as those shown in FIGS. 12-13 and 19, the second interior angle 380B of the first armature 340 is different than the second interior angle 382B of the second armature 342. In aspects, the second interior angle 380B of the first armature 340 is smaller than the second interior angle 382B of the second armature 342. For example, the second interior angle 380B of the first armature 340 may be 120°, and the second interior angle 382B of the second armature 342 may be 130°. Advantageously, when the first and second interior angles 380A, 380B of the first armature 340 are smaller than the first and second interior angles 382A, 382B of the second armature 342, the seat shell 200 may have a rounded bottom such that the seat shell 200 can freely rotate along the support surface 358 while the back 250 can be less rounded to provide for a comfortable occupant experience.

The central component 344 may generally be disposed along the vertical plane 120. In aspects, the central component 344 extends from at and/or near the upper wall 307 of the base 300 along the vertical plane 120 to the bottom 309. In aspects, the central component 344 extends from the rear 308 under the receiving portion 310 to the front 306. In aspects, the central component 344 may have negative curvature when it extends under the receiving portion 310 such that the central component 344 is contoured and concave so as to at least partially extend under the hollow bowl-like shape of the receiving portion 310. In aspects, the central component 344 may be a singular integral component, and in other aspects, the central component 344 comprises any two or more separate components coupled using any one or more of the methods described herein.

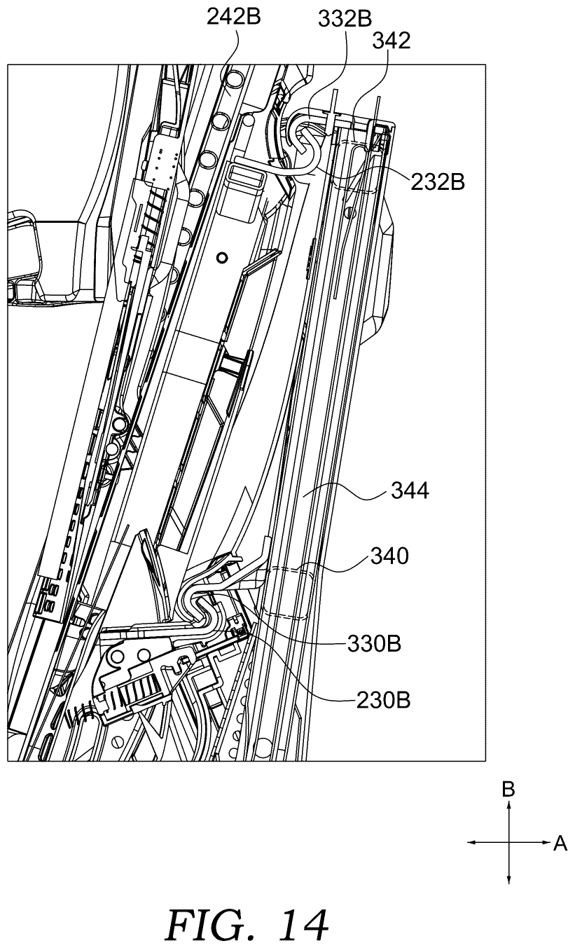

Now referring to FIGS. 14-21, the first pair of engagement features 230A, 230B of the seat shell 200 and the first pair of receiving features 330A, 330B secure the seat shell 200 to the base 300 when in the forward-facing position (as shown in FIG. 1). As is partially shown in FIG. 14, the first pair of engagement features 230A, 230B of the seat shell 200 and the first pair of receiving features 330A, 330B interact and/or engage with each other when the seat shell 200 rotates along the support surface 358 and into the forward-facing position. In exemplary aspects, as the seat shell 200 rotates along the support surface 358, the first engagement feature 230A may slide within the second receiving feature 330B, slide along and out of the second receiving feature 330B, cross the vertical plane 120, and slide into the first receiving feature 330A. In this example, the second engagement feature 230B may slide within the second receiving feature 330B when the first engagement feature 230A slides within the first receiving feature 330A. In aspects, when the first engagement feature 230A slides within the first receiving feature 330A and when the second engagement feature 230B slides within the second receiving feature 330B, the seat shell 200 may be locked into the forward-facing position.

In aspects, the angles of the horizontal axis 217A, 217B of each of the first pair of engagement features 230A, 230B and the angles of the horizontal axis 319A, 319B of each of the first pair of receiving features 330A, 330B relative to the horizontal direction A are the same (e.g., within 3° of each other), such that the first pair of engagement features 230A, 230B can freely slide within the first pair of receiving features 330A, 330B when the seat shell 200 rotates along the support surface 358. Advantageously, by angling the horizontal axes 217A, 217B, 319A, 319B of each of the first pair of engagement features 230A, 230B and each of the first pair of receiving features 330A, 330B, the seat shell 200 may be more resistant to various directional impacts (e.g., lateral, forward, and/or rearward) when coupled to the base 300 such that the seat shell 200 is more resistant to uncoupling from the base 300 upon directional impact.

In aspects, such as those shown in FIGS. 20-21, the pair of forward engagement features 260A, 260B of the seat shell 200 secure the seat shell 200 to the base 300 when the seat shell 200 is in a rearward-facing and/or rearward-reclined position (as shown in FIGS. 20-21). While the position shown in FIG. 20-21 is referred herein as the rearward-facing position, it is contemplated that other reclines and/or seating angles may be preferred in infant CRSs, and the exact recline and/or seating angle shown in FIGS. 20-21 is not intended to be limiting in this respect. As is partially shown in FIG. 21, the pair of forward engagement features 260A, 260B interact and/or engage with the first pair of receiving features 330A, 330B as the seat shell 200 rotates along the support surface 358 and into the rearward-facing position. In exemplary aspects, as the seat shell 200 rotates, the first forward engagement feature 260A may slide within the second receiving feature 330B, slide along and out of the second receiving feature 330B, cross the vertical plane 120, and slide into the first receiving feature 330A. In this example, the second forward engagement feature 260B may slide within the second receiving feature 330B when the first forward engagement feature 260A slides within the first receiving feature 330A.

The second pair of engagement features 232A, 232B of the seat shell 200 and the second pair of receiving features 332A, 332B secure the seat shell 200 to the base 300 when in the forward-facing position (as shown in FIG. 1). As is partially shown in FIG. 14, the second pair of engagement features 232A, 232B of the seat shell 200 and the second pair of receiving features 330A, 330B interact and/or engage with each other when the seat shell 200 rotates along the support surface 358 into the forward-facing position. In exemplary aspects, as the seat shell 200 rotates along the support surface 358, the third engagement feature 232A may slide along and within the fourth receiving feature 332B, slide out of the fourth receiving feature 332B, slide across the vertical plane 120, and slide into the third receiving feature 332A. In this example, the fourth engagement feature 232B may slide within the fourth receiving feature 332B when the third engagement feature 232A slides within the third receiving feature 332A. In aspects, when the third engagement feature 232A slides within the third receiving feature 332A and when the fourth engagement feature 232B slides within the fourth receiving feature 332B, the seat shell 200 may be locked into the forward-facing position.

In aspects, the angles of the horizontal axis 219A, 219B of each of the second pair of engagement features 232A, 232B and the angles of the horizontal axis 321A, 321B of each of the second pair of receiving features 332A, 332B relative to the horizontal direction A are the same (e.g., within 3° of each other), such that the second pair of engagement features 232A, 232B can freely slide within the second pair of receiving features 332A, 332B when the seat shell 200 rotates along the support surface 358. Advantageously, by angling each of the second pair of engagement features 232A, 232B, the seat shell 200 may have additionally increased resistance (e.g., as compared to the first pair of engagement features 230A, 230B and the first pair of receiving features 330A, 330B) to the various directional impacts such that the seat shell 200 is more resistant to uncoupling from the base 300 upon impact. By providing multiple interactions between at least two pairs of engagement and at least two pairs of receiving features, additional securement and retention are provided in the forward-facing position.

In some aspects, the plurality of engagement features 230A, 230B, 232A, 232B, 260A, 260B and the plurality of receiving features 330A, 330B, 332A, 332B do not prevent the seat shell 200 from rotating completely within the receiving portion 310 of the base 300 (e.g., the seat shell 200 may be rotated from the forward-facing position to the rearward-facing position and/or to one or more intermediate positions). In other aspects, the hooks of at least some of the plurality of engagement features 230A, 230B, 232A, 232B, 260A, 260B and the hooks of each of the plurality of receiving features 330A, 330B, 332A, 332B do prevent the seat shell 200 from completing a full rotation. In one example, the angles of the horizontal axes of at least some of the plurality of engagement features 230A, 230B, 232A, 232B, 260A, 260B may allow rotation of the seat shell 200 from the forward-facing position to the rearward-facing position on only one of the lateral or medial sides of the seat shell 200.

In aspects, such as those shown in FIGS. 14-17, the plurality of engagement features 230A, 230B, 232A, 232B, 260A, 260B and the plurality of receiving features 330A, 330B, 332A, 332B do not come into substantial contact with each other when they interact and/or engage with each other. In such aspects, the plurality of engagement features 230A, 230B, 232A, 232B, 260A, 260B and the plurality of receiving features 330A, 330B, 332A, 332B may come into contact when the base 300 and/or the seat shell 200 experience an impact, and the plurality of engagement features 230A, 230B, 232A, 232B, 260A, 260B and the plurality of receiving features 330A, 330B, 332A, 332B may come into contact to retain the seat shell 200 in the base 300 when either experiences such an impact. Advantageously, by limiting contact between the plurality of engagement features 230A, 230B, 232A, 232B, 260A, 260B and the plurality of receiving features 330A, 330B, 332A, 332B when the seat shell 200 and/or the base 300 are not experiencing an impact, the plurality of engagement features 230A, 230B, 232A, 232B, 260A, 260B and the plurality of receiving features 330A, 330B, 332A, 332B may experience less wear over time.

In other aspects, at least one surface of the plurality of engagement features 230A, 230B, 232A, 232B, 260A, 260B and at least one surface of the plurality of receiving features 330A, 330B, 332A, 332B come into continuous contact with each other when they each interact and/or engage with each other. In some aspects, only portions of the at least one surface of the plurality of engagement features 230A, 230B, 232A, 232B, 260A, 260B and only portions of the at least one surface of the plurality of receiving features 330A, 330B, 332A, 332B come into contact with each other when they interact and/or engage with each other. For example, only the lips of each of the plurality of engagement features 230A, 230B, 232A, 232B, 260A, 260B come into contact with only the lips of each of the plurality of receiving features 330A, 330B, 332A, 332B.

In aspects, the plurality of engagement features 230A, 230B, 232A, 232B, 260A, 260B of the seat shell 200 and the plurality of receiving features 330A, 330B, 332A, 332B of the base 300 may be disengaged from each other (e.g., by rotating) to allow the seat shell 200 to be rotated to the one or more intermediate positions (e.g., positions between the rearward-facing position and the forward-facing position).

The following clauses represent example embodiments of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A CRS comprising: a base comprising a receiving portion; a seat shell comprising a seat bottom having a lower portion configured to interface with the receiving portion of the base, wherein the seat shell is rotatable with respect to the base around a rotational axis to selectively position the seat shell in a rearward-facing position and a forward-facing position; a plurality of engagement features; and a plurality of receiving features; wherein each of the plurality of engagement features is configured to engage a corresponding one of the plurality of receiving features when the seat shell is in the forward-facing position, and wherein each of the plurality of receiving features and engagement features is offset from a vertical plane disposed longitudinally and vertically through the rotational axis when the seat shell is in the forward-facing position.

Clause 2. The CRS of clause 1, wherein each of the plurality of engagement features is engaged with the corresponding one of the plurality of receiving features by rotating the seat shell within the receiving portion of the base into the forward-facing position.

Clause 3. The CRS of clauses 1 or 2, wherein the plurality of receiving features comprise a first pair of horizontally aligned receiving features that are positioned on opposite sides of the vertical plane.

Clause 4. The CRS of clause 3, wherein the first pair of horizontally aligned receiving features are positioned proximate to a support ledge along which at least a portion of the seat shell contacts as the seat shell is rotated.

Clause 5. The CRS of clauses 3 or 4, wherein one of the first pair of horizontally aligned receiving features are positioned at an angle between 1 and 80 degrees from the vertical plane, as measured from the rotational axis.

Clause 6. The CRS of any of clauses 1-5, wherein the plurality of receiving features comprise a second pair of horizontally aligned receiving features that are positioned on opposite sides of the vertical plane.

Clause 7. The CRS of clause 6, wherein the second pair of horizontally aligned receiving features are positioned on a backing portion of the base.

Clause 8. The CRS of clause 6 or 7, wherein: a first angle is formed between the first pair of horizontally aligned receiving features as measured from the rotational axis; and a second angle is formed between the second pair of horizontally aligned receiving features; wherein the first angle and the second angle are different.

Clause 9. The CRS of any of clauses 3-8, wherein the first pair of horizontally aligned receiving features are attached to a base structural element at least partially disposed within the base.

Clause 10. The CRS of clause 9, wherein the base structural element comprises a central component disposed along the vertical plane and a first armature extending horizontally across the vertical plane, with the first pair of horizontally aligned receiving features attached to the first armature on either side of the vertical plane.

Clause 11. The CRS of clause 10, wherein the first armature comprises a plurality of segments that are non-parallel with respect to each other.

Clause 12. The CRS of clauses 10 or 11, wherein the base structural element further comprises a second armature connected to the central component and extending horizontally across the vertical plane, the second armature being vertically offset from the first armature, the second armature having a second pair of horizontally aligned receiving features attached to it.

Clause 13. The CRS of clause 12, wherein the first armature and the second armature are non-removably coupled to the central component.

Clause 14. The CRS of clauses 12 or 13, wherein the first pair of horizontally aligned receiving features are integrally formed with the first armature, and the second pair of horizontally aligned receiving features are integrally formed with the second armature.

Clause 15. The CRS of any of clauses 10-14, wherein: the seat shell comprises a seat shell structural element at least partially disposed within the seat shell, and the plurality of engagement features are attached to the seat shell structural element.

Clause 16. The CRS of clause 15, wherein the seat shell structural element comprises a pair of vertically aligned rails connected by at least one horizontal element.

Clause 17. The CRS of any of clauses 2-16, wherein: each of the plurality of engagement features comprises an upward-or downward-oriented hook, and each of the plurality of receiving features comprises a complementary downward or upward-oriented hook.

Clause 18. The CRS of clause 16 or 17, wherein the hooks do not prevent the seat shell from rotating completely within the receiving portion of the base.

Clause 19. The CRS of any of clauses 4 through 18, wherein the seat shell further comprises a pair of forward engagement features configured to engage the first pair of horizontally aligned receiving features when the seat is rotated into the rearward-facing position.

Clause 20. A CRS comprising: a base comprising: a receiving portion, a rounded ledge within the receiving portion; a backing portion extending upwards from a rear of the base, a plurality of receiving features comprising: a first pair of receiving features positioned along the circular support ledge, and a second pair of receiving features positioned on the backing portion, a seat shell comprising: a seat bottom comprising a lower portion configured to interface with the receiving portion of the base, and a plurality of engagement features comprising: a first pair of engagement features; and a second pair of engagement features; wherein the seat shell is rotatable with respect to the base around a rotational axis such that the seat shell is selectively positionable between at least a rearward-facing position and a forward-facing position; and wherein when the seat shell is in the forward-facing position: the first pair of receiving features are configured to engage the first pair of receiving features when the seat shell is in the forward-facing position, the second pair of receiving features are configured to engage the second pair of receiving features when the seat shell is in the forward-facing position, and each of the plurality of receiving features and each of the plurality of engagement features are offset from a vertical plane disposed longitudinally and vertically through the rotational axis.

While particular exemplary embodiments have been described, it is not intended that the claims be limited thereto, as it is intended that the claims be as broad in scope as the art will allow and that the specification be read likewise. That is, the foregoing description of specific embodiments will so fully reveal the general nature of the disclosure that others may, by applying knowledge within the skill of the art, readily modify and/or adapt for various applications with such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It will be appreciated by those of ordinary skill in the art that the components, method steps, and materials illustrated above may be varied by substitution of equivalent components, steps, and materials capable of performing the same functions. It will also be appreciated by one of ordinary skill in the art that sizes and strengths of the components may be scaled up or down as required for specific purposes. The claims hereof are intended to encompass all such equivalent components, method steps, and scales.

What is claimed is:

1. A child restraint system (CRS) comprising:
a base comprising a receiving portion;
a seat shell comprising a seat bottom having a lower portion configured to interface with the receiving portion of the base, wherein the seat shell is rotatable with respect to the base around a rotational axis to selectively position the seat shell in a rearward-facing position and a forward-facing position;
a plurality of engagement features; and
a plurality of receiving features;
wherein each of the plurality of engagement features is configured to engage a corresponding one of the plurality of receiving features when the seat shell is in the forward-facing position, and
wherein each of the plurality of receiving features and engagement features is offset from a vertical plane disposed longitudinally and vertically through the rotational axis when the seat shell is in the forward-facing position.

2. The CRS of claim 1, wherein each of the plurality of engagement features is engaged with the corresponding one of the plurality of receiving features by rotating the seat shell within the receiving portion of the base into the forward-facing position.

3. The CRS of claim 2, wherein the plurality of receiving features comprise a first pair of horizontally aligned receiving features that are positioned on opposite sides of the vertical plane.

4. The CRS of claim 3, wherein the first pair of horizontally aligned receiving features are positioned proximate to a support ledge along which at least a portion of the seat shell contacts as the seat shell is rotated.

5. The CRS of claim 3, wherein one of the first pair of horizontally aligned receiving features are positioned at an angle between 1 and 80 degrees from the vertical plane, as measured from the rotational axis.

6. The CRS of claim 3, wherein the plurality of receiving features comprise a second pair of horizontally aligned receiving features that are positioned on opposite sides of the vertical plane.

7. The CRS of claim 6, wherein the second pair of horizontally aligned receiving features are positioned on a backing portion of the base.

8. The CRS of claim 7, wherein:
a first angle is formed between the first pair of horizontally aligned receiving features as measured from the rotational axis; and
a second angle is formed between the second pair of horizontally aligned receiving features;
wherein the first angle and the second angle are different.

9. The CRS of claim 3, wherein the first pair of horizontally aligned receiving features are attached to a base structural element at least partially disposed within the base.

10. The CRS of claim 9, wherein the base structural element comprises a central component disposed along the vertical plane and a first armature extending horizontally across the vertical plane, with the first pair of horizontally aligned receiving features attached to the first armature on either side of the vertical plane.

11. The CRS of claim 10, wherein the first armature comprises a plurality of segments that are non-parallel with respect to each other.

12. The CRS of claim 10, wherein the base structural element further comprises a second armature connected to the central component and extending horizontally across the vertical plane, the second armature being vertically offset from the first armature, the second armature having a second pair of horizontally aligned receiving features attached to it.

13. The CRS of claim 12, wherein the first armature and the second armature are non-removably coupled to the central component.

14. The CRS of claim 13, wherein the first pair of horizontally aligned receiving features are integrally formed with the first armature, and the second pair of horizontally aligned receiving features are integrally formed with the second armature.

15. The CRS of claim 10, wherein:
the seat shell comprises a seat shell structural element at least partially disposed within the seat shell, and
the plurality of engagement features are attached to the seat shell structural element.

16. The CRS of claim 15, wherein the seat shell structural element comprises a pair of vertically aligned rails connected by at least one horizontal element.

17. The CRS of claim 2, wherein:
each of the plurality of engagement features comprises an upward-or downward-oriented hook, and
each of the plurality of receiving features comprises a complementary downward-or upward-oriented hook.

18. The CRS of claim 17, wherein the hooks of each of the plurality of engagement features and the hooks of each of the plurality of receiving features do not prevent the seat shell from rotating completely within the receiving portion of the base.

19. The CRS of claim 4, wherein the seat shell further comprises a pair of forward engagement features configured to engage the first pair of horizontally aligned receiving features when the seat is rotated into the rearward-facing position.

20. A child restraint system (CRS) comprising:
a base comprising:
a receiving portion;
a rounded ledge within the receiving portion;
a backing portion extending upwards from a rear of the base,
a plurality of receiving features comprising:
a first pair of receiving features positioned along a circular support ledge, and
a second pair of receiving features positioned on the backing portion,
a seat shell comprising:
a seat bottom comprising a lower portion configured to interface with the receiving portion of the base, and
a plurality of engagement features comprising:
a first pair of engagement features; and
a second pair of engagement features;
wherein the seat shell is rotatable with respect to the base around a rotational axis such that the seat shell is selectively positionable between at least a rearward-facing position and a forward-facing position; and
wherein when the seat shell is in the forward-facing position:
the first pair of receiving features are configured to engage the first pair of receiving features when the seat shell is in the forward-facing position,
the second pair of receiving features are configured to engage the second pair of receiving features when the seat shell is in the forward-facing position, and
each of the plurality of receiving features and each of the plurality of engagement features are offset from a vertical plane disposed longitudinally and vertically through the rotational axis.
